(19) United States
(12) Patent Application Publication
(10) Pub. No.: US 2005/0108057 A1
(43) Pub. Date: May 19, 2005

(54) Medical device management system including a clinical system interface

(76) Inventors: Michal Cohen, Malvern, PA (US); John R. Zaleski, West Brandywine, PA (US); Vamsi Chemitiganti, Coatesville, PA (US)

Correspondence Address: Alexander J. Burke;Intellectual Property Department, 5th Floor, 170 Wood Avenue South, Iselin, NJ, 08830, US

(21) Appl. No.: 10/948,037

(22) Filed: Sep. 23, 2004

Related U.S. Application Data
(60) Provisional application No. 60/505,503, filed on Sep. 24, 2003.

(51) Int. Cl. G06F 17/60

(52) U.S. Cl. 705/3

(57) ABSTRACT

An information system for managing operation of medical devices in delivering treatment to a patient, comprising: an order processor for processing a physician order for initiating providing a treatment to a patient; a device management processor for receiving data items from the order processor comprising at least one of, (a) a patient identifier and (b) an identifier for identifying the physician order, and for processing and using the data items in managing access to a medical device used for delivering the treatment to the patient; and a communication interface enabling bidirectional communication between the device management processor and the medical device.

### CROSS-REFERENCE TO RELATED APPLICATIONS

This application claims priority to pending provisional application Ser. No. 60/505,503 (Applicant Docket No. 03P14624US), filed 24 Sep., 2003.

### BACKGROUND

A fixed-format transaction that contains information validated using a checksum and consistent with the use of a hand-held barcode scanner is sometimes used for delivering IV/epidural order information to an IV/epidural health information system and storing it. This approach is consistent with legacy systems using manually operated IV/epidural pumps. Known systems use either hand-held barcode readers or manually entered (i.e., keyed) information to the IV/epidural pump. A system according to invention principles addresses deficiencies of known systems.

### SUMMARY

An information system for managing operation of medical devices in delivering treatment to a patient, comprising: an order processor for processing a physician order for initiating providing a treatment to a patient; a device management processor for receiving data items from the order processor comprising at least one of, (a) a patient identifier and (b) an identifier for identifying the physician order, and for processing and using the data items in managing access to a medical device used for delivering the treatment to the patient; and a communication interface enabling bidirectional communication between the device management processor and the medical device.

### DESCRIPTION OF THE DRAWINGS

The invention and its wide variety of embodiments are more readily understood through the following detailed description, with reference to the accompanying drawings in which:

FIG. 1 is a block diagram of a medical device management system 1000;

FIG. 2 is a flow diagram of a method of use 2000 for managing a medical device;

FIG. 3 is a block diagram of a pump manager architecture 3000;

FIG. 4 is a functional flow diagram 4000 for a medical device management system;

FIG. 5 is a process diagram 5000 for data transmission demographics to an IV pump manager;

FIG. 6 is a process diagram 6000 for an order showing a successful pump order transmission event;

FIG. 7 is a process diagram 7000 for invalid patient demographics sent to a pump manager;

FIG. 8 is a flow diagram of a pump manager web application architecture 8000;

FIG. 9 is a user interface 9000 for logging in to a medical device management system;

FIG. 10 is a user interface 10000 for registration with a medical device management system;

FIG. 11 is a user interface 11000 of a registration error message from a medical device management system;

FIG. 12 is a user interface 12000 for logging in to a medical device management system;

FIG. 13 is a user interface 13000 for a login error associated with a medical device management system;

FIG. 14 is a user interface 14000 displaying available pumps;

FIG. 15 is an exemplary user interface 15000 for monitoring a pump;

FIG. 16 is a user interface 16000 for monitoring a graphical rendering of pump flowrates;

FIG. 17 is a user interface 17000 for graphically displaying pump information;

FIG. 18 is a flow logic diagram 18000 for user interface navigation;

FIG. 19 is an exemplary flow logic diagram 19000 for a medical device management system pump manager application;

FIG. 20 is a block diagram of a process flow 20000 for authentication in a medical device management system diagram;

FIG. 21 is a process flow diagram of a security mapping 21000 for a medical device management system;

FIG. 22 is a flow diagram 22000 for an open link transaction;

FIG. 23 is a process diagram 23000 for a data transmission to a pump manager;

FIG. 24 is a process diagram 24000 for an order sent to a pump manager;

FIG. 25 is a process diagram 25000 for an invalid order sent to a pump;

FIG. 26 is a process diagram 26000 for a successful registration in a medical device management system;

FIG. 27 is a process diagram 27000 for a failed registration in a medical device management system;

FIG. 28 is a process diagram 28000 for a device data check by an authorized user;

FIG. 29 is a process diagram 29000 for successful login to a medical device management system;

FIG. 30 is a process diagram 30000 for an unsuccessful attempt to open a session without logging in;

FIG. 31 is a process diagram 31000 for an unsuccessful login;

FIG. 32 is a block diagram of a database schema architecture 32000;

FIG. 33 is a section of XML code 33000 associated with controlling a device in a medical device management system;

FIG. 34 is an exemplary user interface 34000 for rendering stress test results associated with a medical device management system;

FIG. 35 is an exemplary surgical tray 35000 identifiable and trackable by a medical device management system;

FIG. 36 is a block diagram of an information device 36000; and

FIG. 37 is a process flow diagram 37000 for a medical device management system.

### DEFINITIONS

When the following terms are used herein, the accompanying definitions apply:

absence—a lack of presence.

access—communicate with.

address—an identifier denoting location.

alert—a warning signal.

application—a program adapted to carry out a useful task.

authentication processor—a processor adapted to receive user identification information, determine if a user is authorized to access an application used in managing a particular device, and/or inhibit access to the device by the user in response to a determination that access by the user is unauthorized.

authorize—to grant authority, permission, or power to.

barcode—information expressible as a series of parallel bars of varying widths, in which each of the digits zero through nine are represented by a different pattern of bars that can be read by an optical scanner.

bidirectional—capable of communicating in opposing directions.

communication—an exchange of information.

communication interface—a bus, connector, network adapter, local area network interface, wired network interface, telephone line interface, cellular network interface, broadband cable interface, modem, wireless network interface, radio receiver, transceiver, and/or antenna, etc. A communication interface enables communication between a device management processor and a device.

compatible—the ability of one device or program to work with another device or program.

configure to set up for a particular purpose.

data—numbers, characters, symbols etc., that are related to a subject.

deliver—give forth or produce.

device management processor—a processor adapted to receive data items for processing in managing operation of a device.

determine—ascertain, obtain, calculate, and/or provide.

duration—a period of time.

Ethernet—a type of networking technology.

fail—to be unsuccessful.

field—a logical storage space for a type of data. Fields can contain textual, numeric, date, graphical, audio, video, and/or calculated data. Any text field has properties comprising a fixed or variable length, a pre-defined display format, and/or relatability to another field.

fixed—a stable and/or unalterable form.

flow rate—an amount of liquid provided to a particular place within a stated time period.

fluid infusion pump—a device adapted to propel a liquid into a patient.

fluid medication—a substance, delivered in a liquid medium, that treats, prevents, and/or alleviates the symptoms of at least one medical condition.

fluid volume—an amount of space occupied by a liquid.

format—an arrangement and/or parameter of data relating to the packetizing, conveying, communicating, presenting display, and/or rendering of that data.

generate—an act of processing or producing.

geographic location—a position on the earth.

greater—larger and/or more than.

group—a number of individuals or things considered together because of similarities.

hierarchy—a series of ordered groupings of people or things within a system.

HealthLevel 7—a healthcare specific communication standard for data exchange between computer applications.

healthcare—the prevention, treatment, and/or management of illness and the preservation of mental and physical well being through the services offered by the medical and allied health professions.

identification device—a device adapted to provide and/or transmit information used to identify an entity. For example, an RFID is an embodiment of an identification device.

identifier—a group of symbols that are unique to a particular entity, activity, and/or document. An identifier can be, for example, a medical record number. An identifier can be human and/or machine readable, such as for example, a number, an alphanumeric string, a bar code, an RFID, etc.

identify—to establish an identity of.

inactive session—an idle connection between two information devices.

inhibit—prohibit and/or forbid.

initiate—begin.

information—data.

information device—any processing device (in software or hardware) capable of processing information, such as any general purpose and/or special purpose computer, such as a personal computer, workstation, server, minicomputer, mainframe, supercomputer, computer terminal, laptop, wearable computer, and/or Personal Digital Assistant (PDA), etc.

interrogate—ask.

IP (Internet Protocol)—a network protocol that specifies the format of packets, also called datagrams, and the addressing scheme for the packets. By itself, IP is a protocol for providing a message from a source to a network, but does not establish a direct link between the source and the destination. TCP/IP, on the other hand, can establish a connection between two communicators so that they can send messages back and forth for a period of time.

item—a single article or unit.

location—a place substantially approximating where something physically exists.

MAC (Media Access Control) address—an address for a device as it is identified at the Media Access Control layer in a network architecture.

machine-readable—of a form from which an information device can obtain data and/or information.

manage—direct and/or control.

map—a logical association of values of one variable with values of a different variable.

medical condition—a patient health status characterized by at least one symptom.

medical device—an apparatus adapted for diagnosing an illness and/or application of a medication.

medication—a substance adapted to relieve at least one symptom of and/or cure a medical condition.

medication order information—data related to the dispensing of medicine in a healthcare system.

member—an entity classified as being a part of a logical group.

message—a communication.

monitor—observe.

multiple login attempts—more than one try at authentication in a system with restricted access.

new user registration—an act of recording and/or documenting a first-time user.

non-scanned—not digitally encoded via an optical scanning device.

operation—a series of actions in performing a function.

operational characteristic—a feature associated with an operation.

order—(n.) an authoritative indication to be obeyed.

order—(v.) to issue an authoritative instruction.

order processor—a processor adapted to process an order for initiating management of an operation. For example, in medical device management systems, an order processor is adapted to initiate providing a treatment to a patient.

organized—ordered and/or arranged.

particular—specific.

patient—a human or other type of animal under supervision for health care purposes.

patient management information—data related to the care and/or medication of a patient.

patient monitoring device—an apparatus adapted to observe and/or sense information related to the well being of a patient.

patient specific—associated with and/or peculiar to a particular patient.

patient usage—an amount or amounts of substances administered to a patient.

perform—carry out.

permitted—allowed.

pharmacy information—data related to dispensing medications.

physician—a person licensed to practice medicine.

predetermined—established in advance.

processor—any device and/or set of machine-readable instructions adaptable to perform a specific task. A processor comprises any one or combination of hardware, firmware, and/or software adaptable to perform a specific task. A processor acts upon information by manipulating, analyzing, modifying, converting, transmitting the information to an information device, and/or routing the information to an output device.

provide—furnish or supply.

radio frequency identification (RFID)—a technology wherein electromagnetic or electrostatic coupling in the RF portion of the electromagnetic spectrum is typically used to transmit signals to automatically identify people or objects. There are several methods of identification, but the most common is to store a serial number that identifies a person or object, and perhaps other information, on a microchip that is attached to an antenna (the chip and the antenna together are called an RFID transponder or an RFID tag). The antenna enables the chip to transmit the identification information to a reader. The reader converts the radio waves reflected back from the RFID tag into digital information that can then be communicated with information devices.

record—a collection of data elements.

recording—an act of preserving information.

registered—formally recorded and/or accorded authority. For example, a registered user is identified and/or recorded by a medical device management system and is associated with, and accorded authority to use and/or control, a particular medical device.

repository—a device or database in which data is stored.

re-stocking—to replenish and/or replace a depleted inventory.

resource—something used for support or help.

required—necessary and/or essential.

safe—relatively free from risk or danger.

safety check—an inspection adapted to determine whether some thing or act meets a risk threshold.

safety determination—an evaluation adapted to determine whether some thing or act meets a risk threshold.

status information—data relating to a descriptive characteristic of a device and or system.

succession—consecutively arranged.

system—a collection of mechanisms, devices, and/or instructions, the collection performing one or more specific functions.

tag—an attachment adapted to identify, classify, and/or label, etc. For example, a tag is typically a radio frequency identification device (RFID).

test—evaluate.

tracking processor—a processor adapted to record identification information related to the use and/or control of a device.

treatment—administration or application of one or more remedies to a patient or for a disease or injury.

unauthorized—not endowed or provided with authority.

unregistered—not formally recorded and/or accorded authority.

user—a person interfacing with an information device.

ventilator—a respirator. A ventilator is used to assist patient breathing.

wireless—any data communication technique that utilizes electromagnetic waves emitted by an antenna to communicate data (i.e., via an unguided medium), including such data communication techniques as sonar, radio, cellular, cellular radio, digital cellular radio, ELF, LF, MF, HF, VHF, UHF, SHF, EHF, radar, microwave, satellite microwave, laser, infrared, etc., and specifically excluding human voice radio transmissions, the data communication technique having a carrier frequency ranging from about 1 Hz to about 2×10¹⁴ Hz (about 200 teraHertz), including any values therebetween, such as for example, about 40 Hz, 6.010 kHz, 8.7 MHz, 4.518 GHz, 30 GHz, etc. and including any subranges therebetween, such as for example, from about 100 kHz to about 100 MHz, about 30 MHz to about 1 GHz, about 3 kHz to about 300 GHz, etc. Wireless communications can include analog and/or digital data, signals, and/or transmissions.

### DETAILED DESCRIPTION

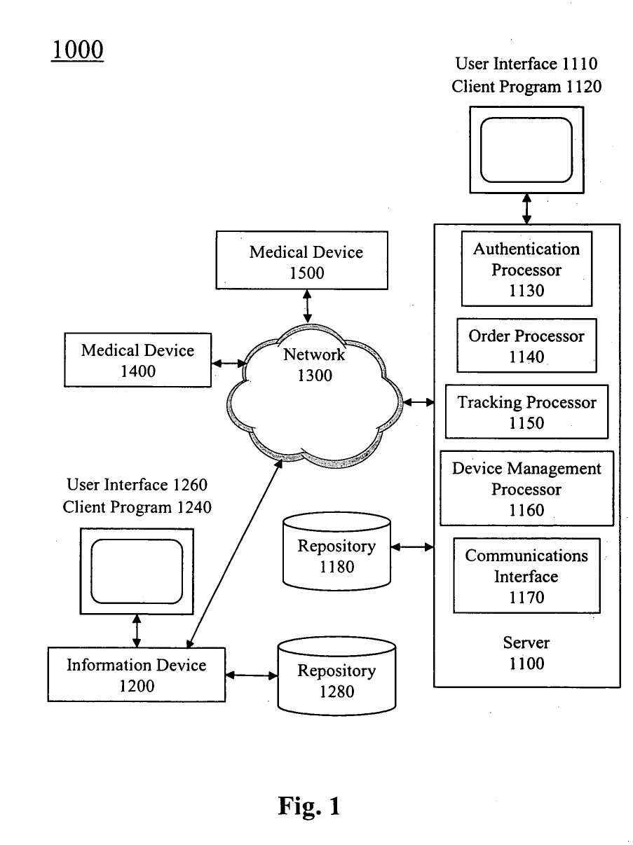

FIG. 1 is a block diagram of a medical device management system 1000, which comprises a server 1100, an information device 1200, a network 1300, a medical device 1400 (e.g., a pump, ventilator, and/or monitoring device, etc.), and/or a medical device 1500, etc. Server 1100 comprises a user interface 1110 and/or a client program 1120. Applications for client program 1120 comprise authenticating a user; processing an order, such as an order for medication delivery via medical device 1400 and/or medical device 1500; monitoring medical device 1400 and/or medical device 1500; and/or communicating with medical device 1400 and/or medical device 1500. User interface 1110 receives input from, and/or renders output to, a user.

A physician generates an order verbally, in writing, by gesture, and/or via machine entry (e.g., such as via typing with a computer keyboard), and relevant information regarding the order can be generated, processed, and/or transmitted for manual and/or automatic implementation of at least a portion of the order. Initially and/or after processing, an order comprises information regarding the physician, the patient, the medication, the device for administering the medication, and/or the condition being treated, etc. Regarding the medication, the order typically indicates a generic type, a brand, compounding instructions, a dosage, a frequency of administration, a rate of administration, a route of administration, and/or other medication administration specifics, etc.

Server 1100 comprises an authentication processor 1130, an order processor 1140, a tracking processor 1150, a device management processor 1160, and/or a communications interface 1170. Authentication processor 1130 receives user identification information such as a username, password, pre-assigned moniker, social security number, barcode identifier, pass code, personal identification number, and/or biometric identifier, etc.

Biometrics is a technology that statistically analyzes and/or compares measured biological data, such as relatively unique physical characteristics, such as fingerprints. A digital system, such as medical device management system 1000 can utilize biometrics to identify and/or authenticate individuals. Biometric features used for identification and/or authentication comprise fingerprints; face, iris, and retina scanning; and/or voice identification; etc. Biometric devices typically include and/or utilize a scanning or reading device, software to convert the scanned information into a digital format, and/or a memory to store biometric information for comparison with stored records. The software identifies specific matched points of data that have been obtained from a scanning and/or reading device and compares them with stored data associated with individuals.

Authentication processor 1130 determines whether a user is a member of a predetermined group of authorized users permitted to access information related to, and/or an application used in managing, medical device 1400 and/or medical device 1500. Authentication processor 1130 inhibits access to information concerning, and/or an application used in managing, device 1400 and/or device 1500 in response to a determination that access is unauthorized. Authentication processor 1130 maintains a record indicating a hierarchy of users able to view corresponding hierarchically organized information based on user authorization level.

Order processor 1140 processes an order to initiate the provision of a treatment to a patient. The order comprises data items such as an originating physician, patient identifier (e.g., patient name, patient number and/or a social security number, etc.), an identifier for identifying the order (e.g., an order number, prescription number, physician number, and/or treatment number, etc.), patient specific healthcare related information (e.g., allergies, admission date, and/or procedure identifier, etc.), and/or information related to a patient specific medical condition (e.g., a diagnosis of hypertension), etc. Order processor 1140 performs activities comprising: initiating a communication of information associated with a particular medical device to a pharmacy information system for use in preparing and re-stocking medications, initiating a communication of information associated with the particular medical device to a medication order information system for use in monitoring usage of a particular medication, and/or initiating a communication of information associated with the particular medical device to a patient management information system for monitoring the patient's condition, etc.

Tracking processor 1150 is adapted to record information comprising user identification information, and/or an audit trail of user activity related to the medical device, etc. An audit trail records actions such as, for example, medical device information accessed, changes to medication, changes to a medication dosage, and/or changes to a ventilator volume, etc.

Device management processor 1160 receives data items from order processor 1140, processes the data items, and/or uses the data items to manage access to medical device 1400 and/or medical device 1500 as used for delivering a treatment to a patient. Data items comprise a physician identifier, patient identifier, user identifier, medical unit identifier, medical record number, prescription identifier, prescription dosage, medical pump flow rate, patient diagnosis, patient medical allergies, and/or procedure associated with a particular patient, etc. Device management processor 1160 receives data items from the order processor in a message of predetermined format having predetermined data fields (e.g., in the form of a formatted database record). The message of predetermined format comprises a HealthLevel 7 (HL7) compatible message. Managing access to medical device 1400 and/or medical device 1500 comprises managing access to information concerning each respective medical device.

Managing access to medical device 1400 and/or medical device 1500 occurs responsive to a determination that the user is authorized and/or registered. The determination that the user is authorized results from comparing an identifier associated with the user with a list of preauthorized users. The list of preauthorized users is typically associated with personnel records for a medical organization. Registered users are authorized users that have been granted particular rights and permissions in the management of device 1400 and/or medical device 1500. As an example, Nurse Jones is authorized to operate IV pumps on the west wing of floor 12 of a particular hospital, but not on the east wing or on other floors. Device management processor 1160 uses at least one data item in configuring the medical device for delivering the treatment to the patient. Actions of device management processor 1160 relative to medical device 1400 and/or medical device 1500 comprise interrogation for status information, performance and/or communications tests, determination of a location, determination that access, and/or performance of a safety check to determine whether it is safe to initiate the treatment, etc.

Server 1100 is communicatively coupled to a repository 1180. Repository 1180 is adapted to store patient related information. Much of the patient related information stored in repository 1180 is typically patient specific. Patient specific information comprises name, gender, identification number, birth date, next of kin, diagnosis, prescribed medications, and/or age, etc. Patient information comprises patient specific information, insurance provider information, insurance group code, physician, medical facility department by which the patient is being treated, available medications, and/or procedures to be performed, etc.

Device management processor 1160 uses data items and/or patient specific information for determining whether it is safe to use medical device 1400 and/or medical device 1500 for delivering the treatment to the patient. The determination of whether it is safe to use medical device 1400 and/or medical device 1500 for delivering the treatment to the patient is based on a presence or an absence of required data in a predetermined data field of the message. For example, treatment is not deemed safe in the absence of information comprising a physician identifier, prescription number, and/or patient number, etc. As another example, a prescribed drug treatment is deemed safe in the absence of data in a field for listing known drug allergies. Device management processor 1160 determines whether it is safe to use medical device 1400 and/or medical device 1500 in response to a user authorization determination. Device management processor 1160 makes the safety determination differently for a patient without patient specific information available in repository 1180 than for a patient having patient specific information available in repository 1180. For example, an outpatient is not approved for open-heart surgery, but an inpatient is approved. Device management processor 1160 makes a safety determination for a patient without patient specific information available in repository 1180, based on an absence of required data in a predetermined data field of the message. For example, giving a patient penicillin is determined as unsafe in the absence of an answer to a question asking whether the patient is known to have any allergies. Device management processor 1160 makes a safety determination for a patient having patient specific information available in repository 1180, based on comparing data in a predetermined data field of the message with data in repository 1180.

Responsive to the safety determination, device management processor 1160 initiates generation of an alert message for communication to an administrator. Alert messages comprise alerting of a new user registration, alerting when multiple login attempts fail in succession, alerting of an inactive session greater than a predetermined duration, and/or alerting when a user attempts to access an unauthorized resource, etc.

Device management processor 1160 manages operation of medical device 1400 and/or medical device 1500 using medical device location information derived using a communication address of a device, such as via a radio frequency identification (“RFID”) tag attached to medical device 1400 and/or medical device 1500.

The tag comprises a wireless identification device and a communication address comprising an IP (Internet Protocol) or Ethernet MAC address. Device management processor 1160 derives medical device location information using a map associating a communication address medical device 1400 and/or medical device 1500 with a corresponding medical device geographic location.

Communications interface 1170 enables bidirectional communications between device management processor 1160 and medical device 1400 and/or medical device 1500. Types of communications interface 1170 comprise serial, parallel, USB, Ethernet, token ring, and/or modem, etc.

Medical device management system 1000 comprises a network 1300. Network 1300 is adapted to communicatively couple information devices such as server 1100 and information device 1200. Architectures for network 1300 comprise a direct connection, local area network, wide area network such as the public switched telephone network, Internet, extranet, or any combination thereof. Types of network 1300 comprise a packet-switched, circuit-switched, connectionless, connection-oriented network, interconnected networks, or any combination thereof. Orientations of network 1300 comprise voice, data, or voice and data communications. Moreover, transmission media of network 1300 comprise wireline, satellite, wireless, or a combination thereof, etc.

Information device 1200 is adapted to receive information transmitted from sever 1100. Information device 1200 comprises components such as a user interface 1260, and a client program 1240. User interface 1260 is adapted to render information regarding medical device management to a user. Client program 1240 is adapted to accept information from the user related to medical device management.

Information device 1200 can be communicatively coupled to a repository 1280. Repository 1180 and/or repository 1280 are adapted to store information obtained from and/or provide information to information devices communicatively coupled to network 1300. Repository 1180 and/or repository 1280 are adapted to store information related to medical device management in a manner allowing the information to be accessible from devices communicatively coupled to network 1300.

Repository 1180 and/or repository 1280 are devices capable of storing analog or digital information, for example, a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc. Repository 1180 and repository 1280 are adapted to store information related to medical device management. Formats to store information on repository 1180 and/or repository 1280 comprise database standards such as XML, Microsoft SQL, Microsoft Access, MySQL, Oracle, FileMaker, Sybase, and/or DB2, etc.

Information stored on repository 1180 and/or repository 1280 comprises at least one of patient specific information, medication information identifying characteristics of a medication being delivered in a treatment, operational characteristics of a fluid infusion pump, medical device location information, medical device IP or Ethernet compatible MAC address, authorized user identification information, infusion pump fluid delivery flow rate, and/or infusion pump fluid volume delivered, etc.

Device 1400 and/or device 1500 are used for delivering a treatment to a patient. Embodiments of device 1400 and/or device 1500 comprise medication delivery pumps, ventilators, temperature monitoring devices, blood pressure monitoring devices, and/or electrocardiograms, etc.

Medical device management system 1000 integrates a medical device management and order interface system, which expedites the process of entering patient information and order data related to medications. The medical device management and order interface system directly translates an order from a HealthLevel 7 (HL7) compatible or other data format, into a machine-readable barcode transaction, such as a non-scanned barcode formatted transaction. The non-scanned barcode formatted transaction is interpreted directly by medical device medical device 1400 and/or medical device 1500. Medical device management system 1000 comprises utilities for authentication, security, and reporting. Medical device management system 1000 controls and regulates a specific domain of users of medical devices based in a healthcare setting. Medical device management system 1000 allows registration of new users, automatic administrator notifications, alerts, and/or updates to a user log database. Authentication of medical device 1400 and/or medical device 1500 is facilitated by associating the specific device with a list of practitioners, such as nurses, who are allowed to manage medical device 1400 and/or medical device 1500. A browser-based architecture for medical device management system 1000 supports user mobility.

System features of medical device management system 1000 comprise: employment of a pluggable and customizable generic architecture; minimization of problems related to user mobility; a flexible Web Manager security architecture that allows for plugging in of new modules without changing the existing code base, for example: SSL support, GSM support, etc.; platform independence; a real-time graphical view of device information; and/or a dynamically updated operational dashboard providing insight into device operations. As used herein, the term “SSL” means Secure Socket Layer, a protocol used to provide encrypted communications on the Internet. As used herein, the term “Global Session Manager, or GSM means a software module used for authentication and authorization.

Medical device management system 1000 provides authentication, security, and reporting sub-systems, which control and regulate device users in a healthcare setting. Medical device management system 1000 utilizes software for controlling medical device 1400 and/or medical device 1500, either of which can include one or more IV and/or epidural pumps. Medical device management system 1000 establishes a security mechanism for regulating access to medical device 1400 and/or medical device 1500 by authorized users and refusing access to unauthorized users.

Via system 1000, an originator of an order can send the order, such as for a medical device, directly to a database engine, related to medical device 1400 and/or medical device 1500, using an interface engine. The database engine: stores this transaction, processes the order, checks for validity of information comprised in the order, stores relevant information in a database, and/or sends the order to medical device 1400 and/or medical device 1500, etc. There is not necessarily a need to generate a barcode for each patient, to optically scan the barcode, or to manually enter demographics or orders at locations such as the pharmacy and/or the medication pump. Medical device management system 1000 automates the process of translating order transactions into fixed-format transactions stored within the database for delivery to the pharmacy, medical device 1400, and/or medical device 1500.

Medical device management system 1000 provides user interface 1110 and a method for processing orders received from a standard medication administration system and translates these into HL7 version V2.4, and/or HL7 version V2.5 orders that can be directed to manage and/or control medical device 1400 and/or medical device 1500.

Medical device management system 1000: communicates via either raw socket connectivity or via a data exchange application; validates transactional content; directs storage of order data items within a pre-defined SQL Server database, such as a database residing in repository 1180; and/or validates the content of the transaction by confirming that each transaction contains valid patient, dosage, and network connectivity between the database and a medical device; etc. In addition, medical device management system 1000 accurately performs error checking and/or correction, such as computing checksum information, to confirm that data have not been corrupted in the process of delivery to the database and/or medical device.

Table I comprises hardware configurations for various servers and/or information devices, such as server 1100 and/or information device 1200. Optimizing performance for a given hardware configuration involves minimizing response times for a given transaction load. As used herein, the term “Apache Tomcat” refers to a Servlet container that is used in a reference implementation for Java Servlet and JSP technologies. Tomcat is an open source implementation that is used as a Web server. Tomcat runs Servlets and JavaServer Pages (JSP) in Web applications. The Apache Foundation is community of open-source software projects headquartered in Forest Hill, Md. As used herein, the term “Apache Jmeter” refers to a Java application that load tests functional behavior and measures performance

TABLE I

| | | Database | | | |
|---|---|---|---|---|---|
| | | server | | | |
| | | (running | | Client | Performance |
| | Web Server | Microsoft | OPENLink | (running | Test machine |
| | (running | SQL | server | Internet | (running |
| | Apache | Server | (version | Explorer v | Jakarta |
| | Tomcat) | 2000) | 23.1) | 6.0.2) | Jmeter) |
| Type | IBM | IBM PC | IBM PC | IBM | IBM PC |
| | ThinkPad | | | ThinkPad | |
| | T23 | | | T23 | |
| CPU | P-III 1.3 GHz | P-2 433 MHz | P-2 433 MHz | P-2 600 MHz | P-III 1.3 GHz |
| RAM | 256 MB | 256 MB | 256 MB | 256 MB | 256 MB |
| Hard | 40 GB | 60 GB | 20 GB | 40 GB | 40 GB |
| Disk | | | | | |
| Network | Ethernet Pro | Ethernet | Ethernet Pro | Ethernet | Ethernet Pro |
| Adapter | 100 | Pro 100 | 100 | Pro 100 | 100 |

While a number of factors can affect performance, adding additional resources in the following two ways, or a combination of both, can be used to good effect:
first, vertical scaling, which involves creating additional web server processes on a single physical machine in order to provide multiple thread pools, each corresponding to a JVM associated with each web server process. As used herein, the term “JVM” means Java Virtual Machine, which is an abstract computing machine, or virtual machine. JVM is a platform-independent execution environment that converts Java code into a machine language and executes it;
second, horizontal scaling, which involves creating additional web server processes across multiple physical machines.

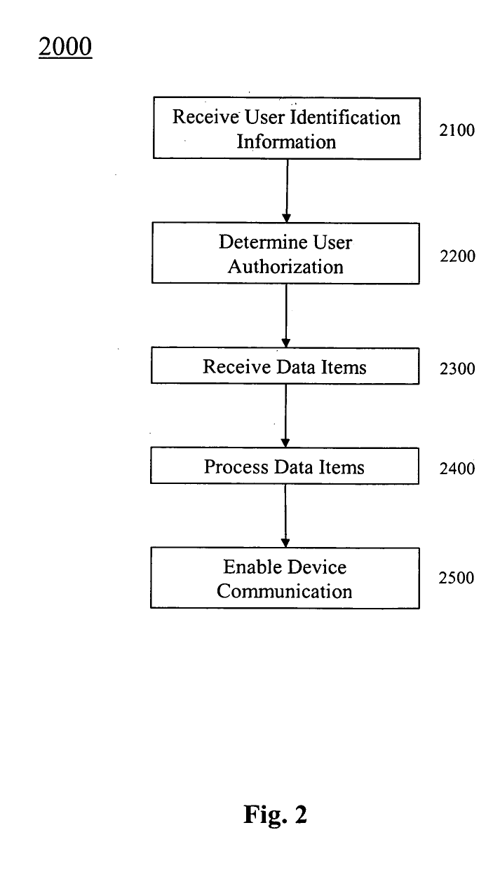

FIG. 2 is a flow diagram of an exemplary embodiment of a method of use 2000 for managing a medical device. At activity 2100, user identification information is received. For example,

At activity 2200, user authorization is determined. Once authorization is determined, the user is authorized to access an application used in managing a particular medical device used for delivering a treatment to a patient. Access is inhibited in response to a determination access is unauthorized. A user is also registered and/or associated with the particular medical device in order to access the application used in managing the particular medical device. For example,

At activity 2300, data items, such as from an order from a physician, are received. The data items comprise a patient identifier and/or an identifier for identifying the order. The data items are in a message of predetermined format having predetermined data fields. For example, data items from the order comprise predetermined information such as patient name, prescription number, medication identification, and/or medication dosage, etc. Each data item is provided in a predetermined format.

At activity 2400, the data items are processed. Treatment is initiated responsive to processing the data items, such as via activation and control of a pump delivering medication to the patient. Processed information provides information such as medication and/or dosage rate usable for controlling the particular medical device, such as an intravenous (IV) and/or epidural pump.

At activity 2500, communications with the device are enabled. Communications with the device is bidirectional and responsive to both user identification and data items received and/or processed. The communication can comprise at least one data item and/or information related to the order. For example,

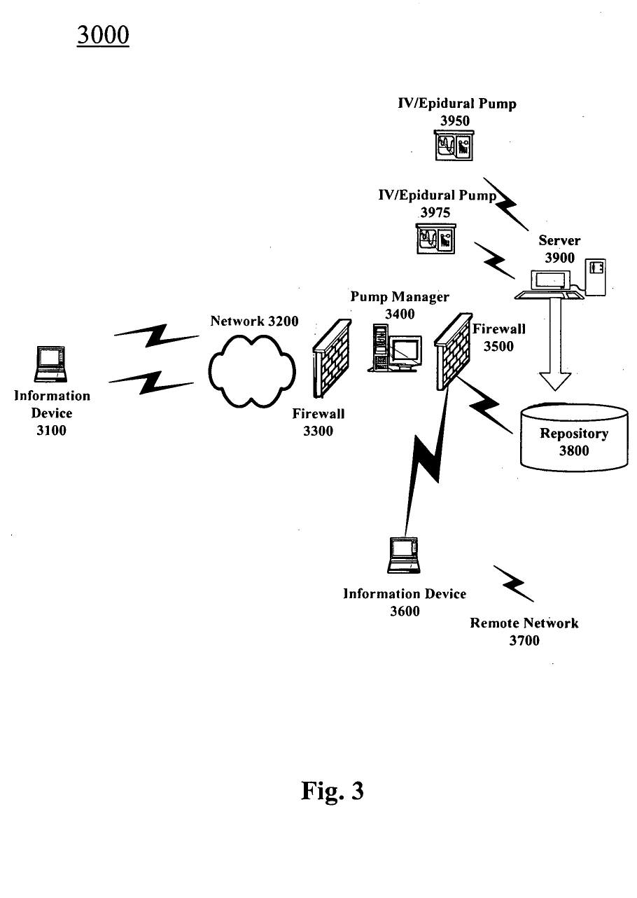

FIG. 3 is a block diagram of a pump manager architecture 3000, which comprises an information device 3100. Information device 3100 allows a user, such as a physician, pharmacy, and/or administrator, etc. to monitor medical devices such as IV/epidural pump 3950 and/or IV/epidural pump 3975. Information device 3100 is communicatively coupled to other information devices via a network 3200. A pump manager 3400 is communicatively coupled to information device 3100 via network 3200 through a first firewall 3300. First firewall 3300 protects pump manager 3400 from unauthorized access and/or control by unauthorized parties. Pump manager 3400 receives orders to manage and/or monitor IV/epidural pump 3950 and/or IV/epidural pump 3975. Pump manager 3400 is communicatively coupled to an information device 3500 and a server 3900 through a second firewall 3500. Second firewall 3500 further protects pump manager 3400 from unauthorized access and/or control.

Information device 3600 provides a user, such as a nurse, with software and a user interface for managing IV/epidural pump 3950 and/or IV/epidural pump 3975. Via information device 3600, the user receives information such as patient ID, medication type, medication dosage, medical device identification and/or patient condition, etc. The user causes medications and equipment to be properly placed for fulfillment of orders. Data items related to orders are transferred to server 3900. Server 3900 causes data item storage in a database residing on repository 3800 in any one of a plurality of database storage standards. Server 3900 provides control and/or dosage information to IV/epidural pump 3950 and/or IV/epidural pump 3975. IV/epidural pump 3950 and/or IV/epidural pump 3975 deliver ordered medications to patients.

Factors considered in providing system configurations comprise size and capacity of available systems and the characteristics of web applications. Depending on the number of database reads/updates etc, it makes sense to isolate the database server to give it a maximum amount of power.

Software managing the medical device is configurable as a three-tiered web application that resides on a web application server and interacts with an SMTP mail server. As used herein, the term “SMTP” means simple mail transfer protocol, which is a standard by which many electronic mail communications occur. In a web-based configuration, data architecture can be based around a SQL Server database engine. Clients are web pages generated as JSP pages deployed in Apache Tomcat, a JSP/Servlet engine. As used herein, the term “Java” means a programming language developed by Sun Microsystems, Santa Clara, Calif. As used herein the term “JSP” means Java server pages, which are web pages developed via a server-side technology developed by Sun Microsystems. As used herein, the term “Servlet” means a small program that runs on a server. The device management software allows for streamlining workflow for the device user (e.g., a nurse having to be tied down to any one physical location in the hospital). The user is able to obtain near real-time updates of device status using graphical tools comprised in the device management software.

The device management software is a multi-tier application that uses a web container but may include EJB/application level containers like JBOSS or functionally equivalent containers. As used herein, the term “EJB” means enterprise Java bean, which is a server-side component architecture for writing reusable business logic and portable enterprise applications. As used herein, the term “JBOSS” means an application server written in Java that can host business components developed in Java. A pluggable architecture has been found to be suitable for administering user level access to the management of IV and/or epidural pumps.

Constraints for implementing device management software comprise support and implementation flexibility; modularity of software (e.g., partitioning presentation and business layers); open architecture capability for handling legacy data sources; platform portability of middleware and software leading to open interfaces, independent at the web container level; and/or cost considerations; etc.

A Java platform supports five enumerated constraints as follows:

JSP pages allow web developers to create content-rich, dynamic pages rapidly and easily. JSP uses XML-like tags to encapsulate logic generating web pages. JSP pages separate page logic from conception and display, which prevents the overlapping of roles between web creators and programmers. As used herein the term “XML” means eXtensible Markup Language, which is a language for software coding primarily used in the development of web pages;
a Java Servlet extends a server's functionality by offering a specific service within a well-defined framework. Java code—often just a single class—provides specific services. For example, an HTTP Servlet may provide a user of the medical device management system with login functionality and security. Another HTTP Servlet could allow an administrator to register new users. As used herein, the term “HTTP” means HyperText Transfer Protocol, which is the underlying protocol used by the world wide web;
JDBC enables database interaction using an open standard and process the returned uniform access to a wide range of relational databases and a common base upon which database tools can be built. As used herein, the term “JDBC” means Java database connectivity, which is a Java API that enables Java programs to execute SQL statements. As used herein, the term “API” means application program interface, which is a set of routines, protocols, and tools for building software applications. A Java connector API, newly released by Sun Microsystems, enables a Java based web container/application server access enterprise information sources; and
a web application, as defined in Servlet specifications, is a collection of Servlets, JSPs, HTML documents, images, and/or other web resources that are set up in such a way as to be portably deployed across any Servlet-enabled web server (Tomcat, the reference Servlet/JSP specification is distributed under an Apache license for deploying web applications in a platform independent manner. As used herein, the term “HTML” means hypertext markup language, which is an authoring language used to create documents on the World Wide Web. In addition, the JavaMail™ API, which is a Java standard extension, provides a strictly protocol-independent method of sending and receiving email. This API is used to inform the administrator of certain important events occurring in the running of the application). If SQL Server is replaced by mySQL in a later release then costs related to relational database management are also ameliorated.

Model-View-Controller (“MVC”) is Java blueprint's recommended architectural pattern for interactive applications. MVC organizes an interactive application into three separate modules: one for the application model with its data representation and business logic, the second for views that provide data presentation and user input, and the third for a controller to dispatch requests and control flow. A medical device management software application framework uses a variation of the MVC pattern. This architecture is applied to solve specific problems associated with IV and/or epidural pump administration by nurses.

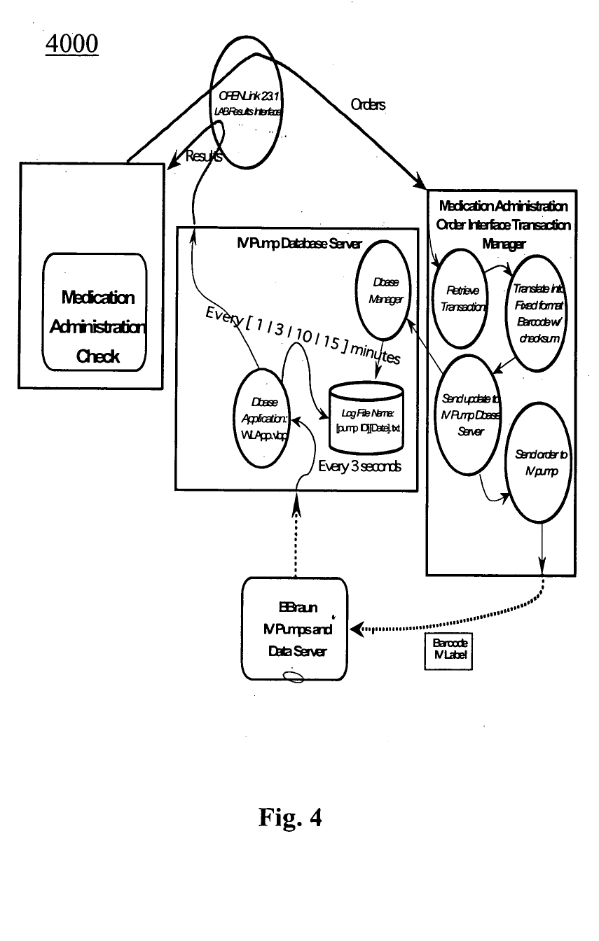

FIG. 4 is a functional flow diagram 4000 for a medical device management system.

Orders related to patient and demographic data are sent from a health information system or a medication administration check to a medication administration order interface transaction system (MAOIT) retrieve transaction sub function via an interface engine that supports data translation, interpretation, and communication among separate and independent software functionality. An interface engine, called “OPENLink.” OPENLink is a system that bidirectionally exchanges data between two different computer systems using compatible or incompatible data communication formats and protocols. Third-party examples of such interface engines are available as well. The use of “OPENLink” in the text is only as an exemplar. Once received demographics data are translated into an equivalent barcode (with a commensurate checksum) and sent to a database manager where the data are stored. Data validity is then checked. If demographics data are valid, patient name and identifiers are recorded in the database.

An IV Pump application composes an acknowledgment message and sends through “OPENLink” to an originating system. Two “OPENLink” interfaces are comprised in the medical device management system: one for outbound vitals transactions, and another for inbound pump medication interactions. The inbound transaction is delivered to the MAOIT application. The outbound transaction is sent from a database application to a health information system, medication administration check, and/or pharmacy.

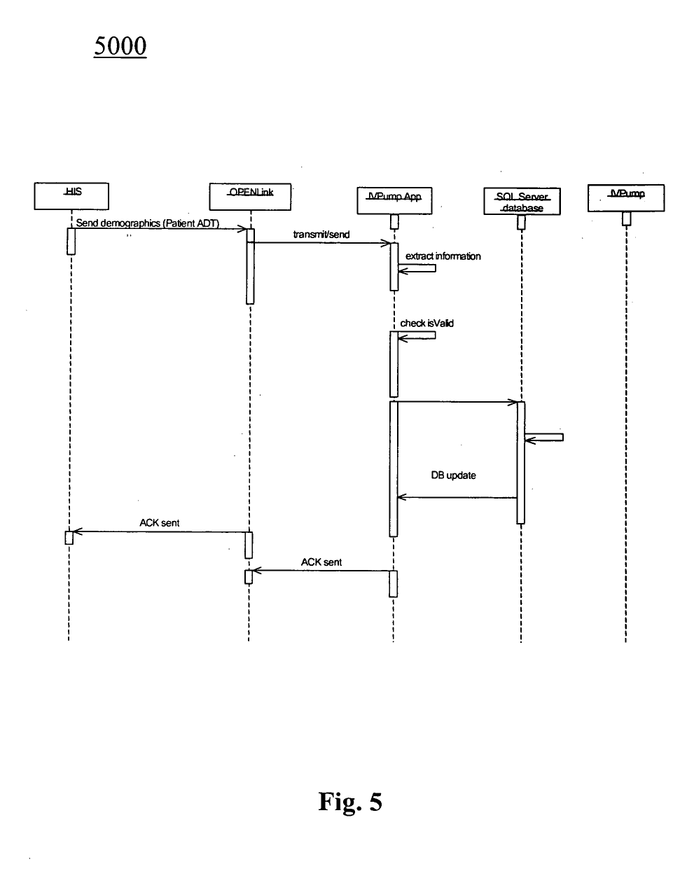

FIG. 5 is a process diagram 5000 for data transmission demographics to an IV pump manager. Process diagram 5000 describes a successful demographics transmission event and shows a sequence of a successful demographics event. A healthcare information system (HIS) originates the event. Information gets checked for validity and then stored in the SQL server database. In this case the medical device (e.g., IV Pump) is not affected and continues in its current mode.

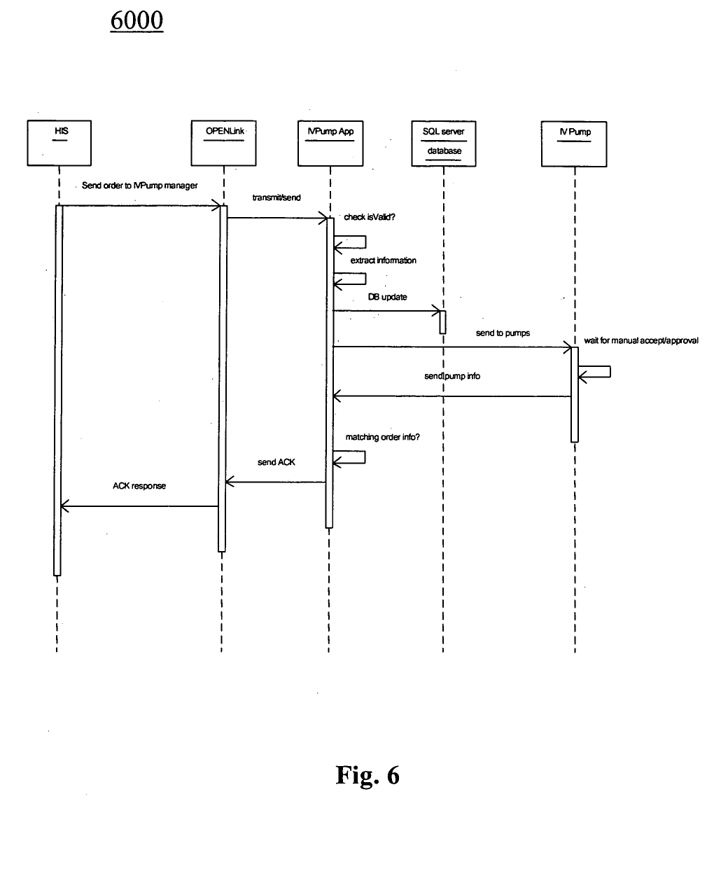

FIG. 6 is a process diagram 6000 for an order showing a successful pump order transmission event. Data associated with an order comprises information an outbound transaction from a mechanical ventilator on a particular patient. RFID tags associate a location of the mechanical ventilator with a patient identifier. A particular ventilator, located at a specific location, assisting a particular patient, receives a specific order, and the result of that order is verified by commensurate outbound vitals transactions from the ventilator at a location associated with a patient medical record number (MRN).

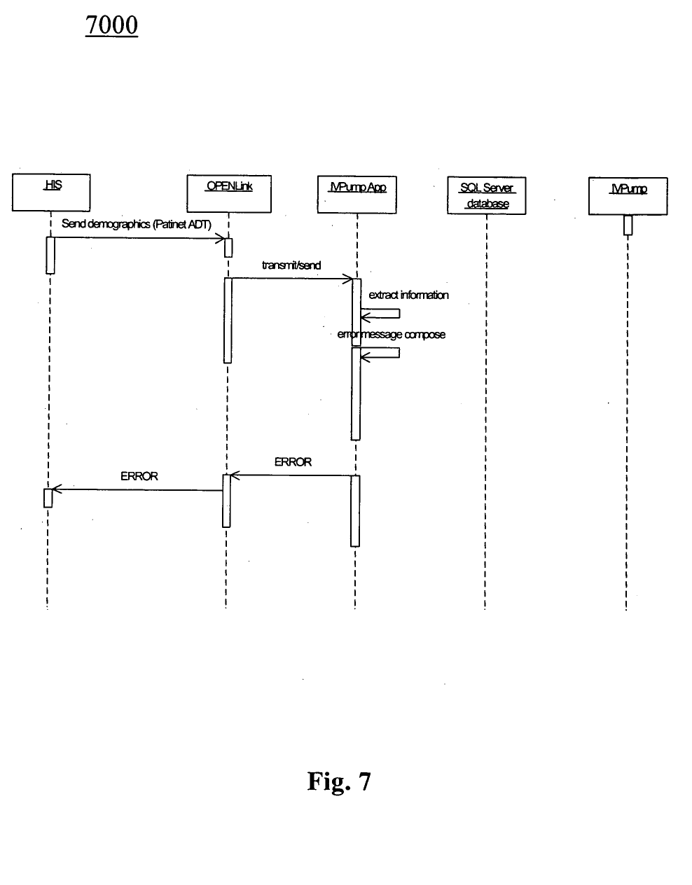

FIG. 7 is a process diagram 7000 for invalid patient demographics sent to a pump manager. Information processed does not affect the information that is stored in an associated database. An error message is sent back to an admission, discharge, and transfer (ADT) originator. For an invalid order sent to a device control manager, such as an IV pump manager, invalid order information does not affect IV pump operations. An error message is sent back to an order originator.

The medical device management system maintains a work and communication flow from an original order to the actual device itself. There is no need for manual maintenance and providing barcodes or scanning their information.

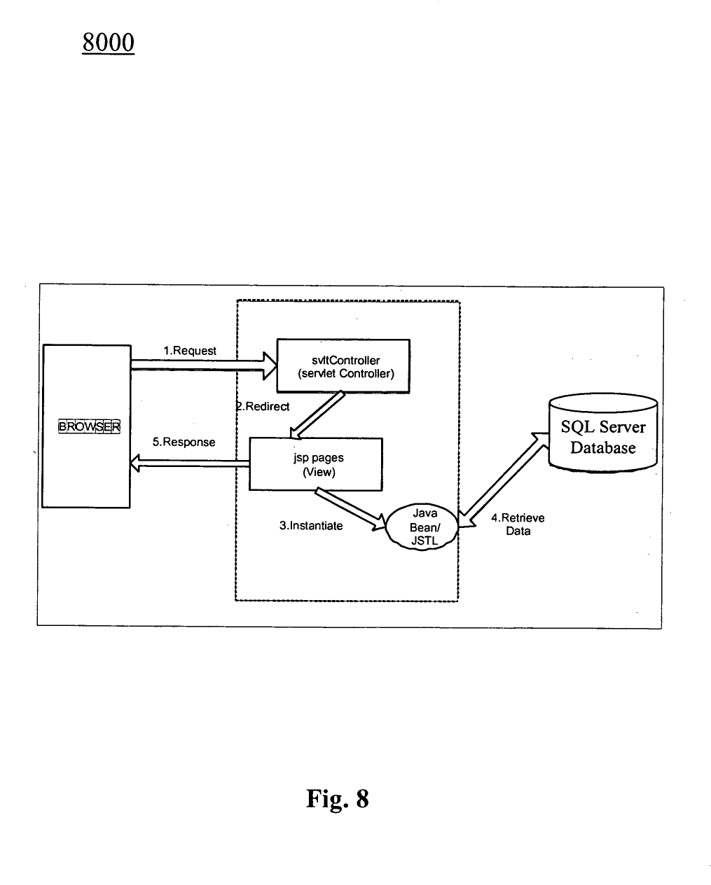

FIG. 8 is a flow diagram of a pump manager web application architecture 8000. The application is partitioned into the following modules:
a user module, which is a web application, through which users login and view IV Pump information and visual statistics. In this embodiment, the users are nurses; and
a registration module, which is a web application that provides new user (nurse) registration. This module also provides a workflow that enables seamless administration of such a system.

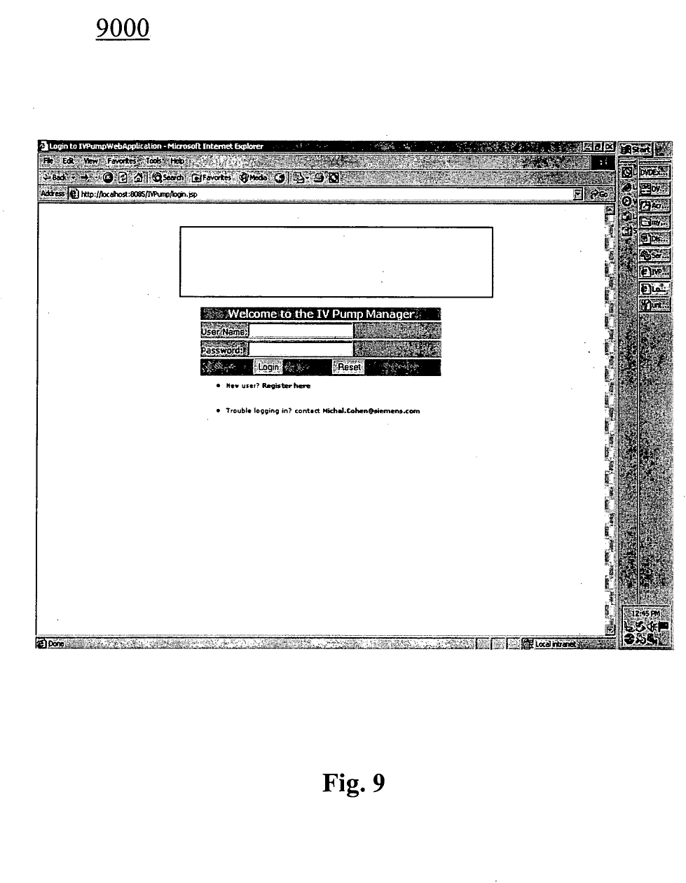

FIG. 9 is a user interface 9000 for logging in to a medical device management system. If the application is installed on a device named “localhost” accessible via a port 8085, the user accesses user interface 9000 via an HTML browser to a URL beginning with the phrase http and including //localhost:8085/IVPump/login.jsp. Ports are identified semi-arbitrarily: specific ports exist that are employed for operating system-level and HIS inter-process communication. These are generally numbered in the range from 0 to 8000. Values of port numbered larger than 8000 are typically used, as they are less likely to conflict with existing application software and operating system communications. User interface 9000 allows the user to login; register as a new user of the pump manager system (unless the user already exists), redirecting the request to a URL accessing a register.jsp page; and e-mail an administrator in the event of a login difficulty.

Automatic alerts are sent to the administrator in the event of any significant events in the system.

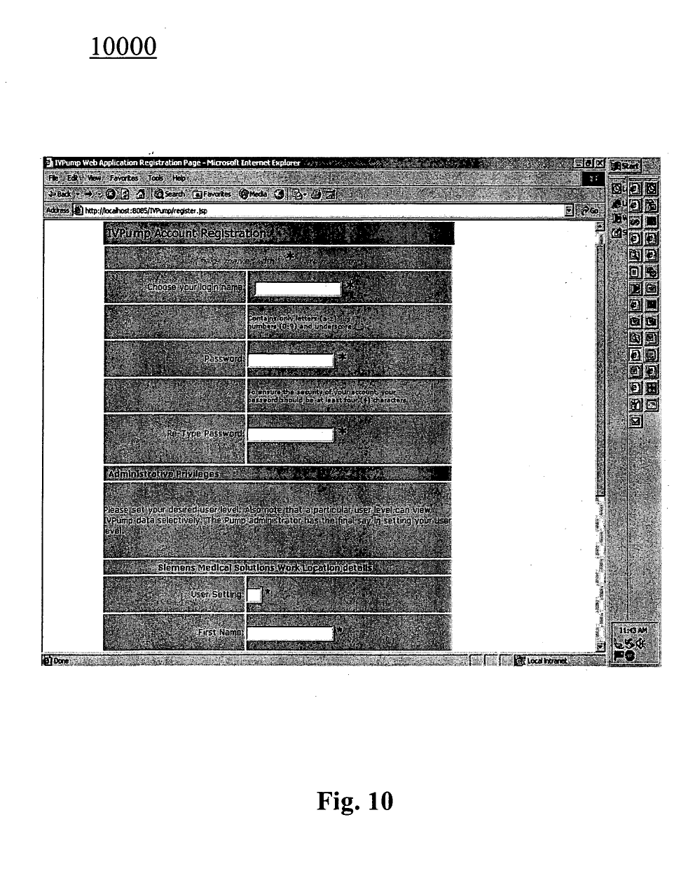

FIG. 10 is a user interface 10000 for registration with a medical device management system. If the user chooses to register as a new user then user interface 10000 (such as an interface resembling register.jsp) is presented. Via user interface 10000, the user: enters a chosen login user name; enters a desired password and confirms it; enters a desired administrative level (overrideable by an administrator); and enters work location details such as a location and/or phone number; etc.

JavaScript is typically used in this page to ensure the user submits required information and to minimize server traffic. Once the user presses “Submit”, this information is entered into the database and the user is redirected to the login page.

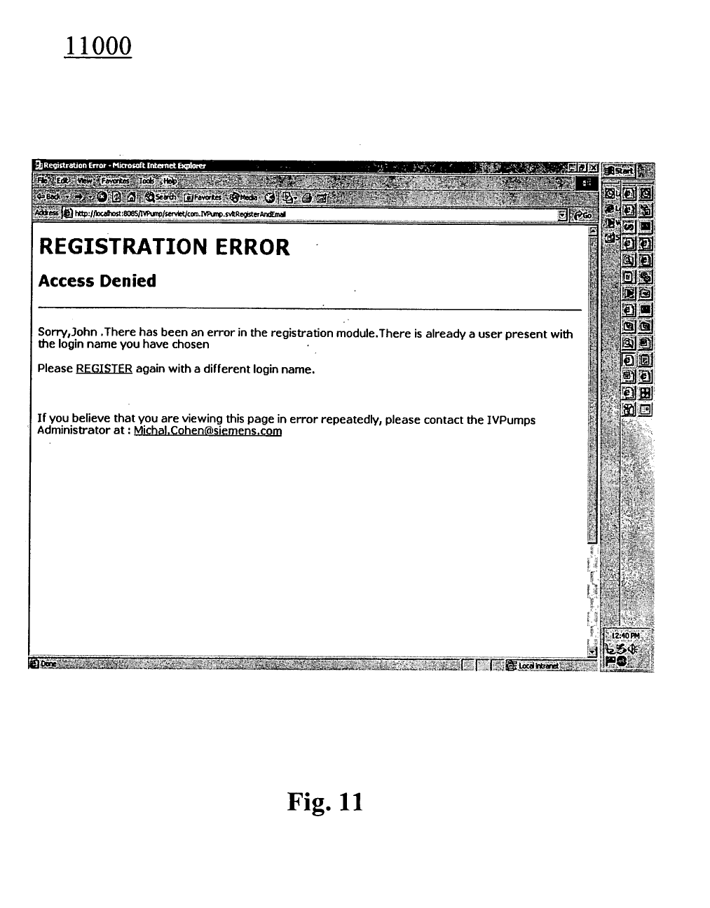

FIG. 11 is a user interface 11000 of a registration error message from a medical device management system. In the event a user exists, already with duplicate information, then the user is presented with user interface 11000 (such as an interface resembling registerError.jsp) and is prompted to choose a different login name.

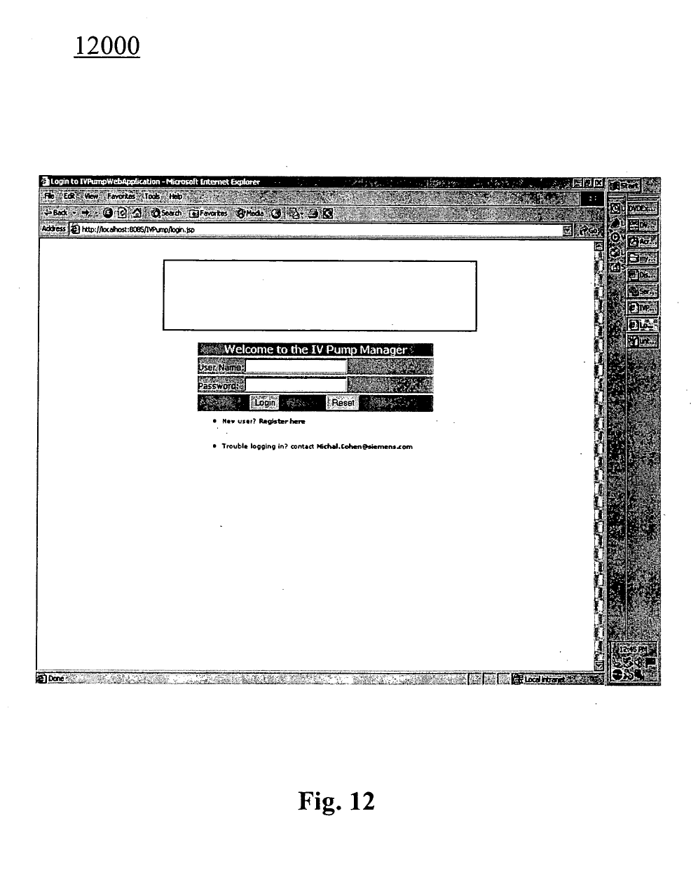

FIG. 12 is a user interface 12000 for logging in to a medical device management system. If the registration is successful, then the user is directed to user interface 12000 to login to the medical device management system. At this point, an email is automatically sent to an administrator. User interface 12000 is displayed using a JavaMail API and the “Java Activation Framework”. As used herein, the term “Java Activation Framework” means a set of standard services, available from Sun Microsystems, to determine the type of an arbitrary piece of data, encapsulate access to it, discover operations available on it, and to instantiate an appropriate bean to perform operations.

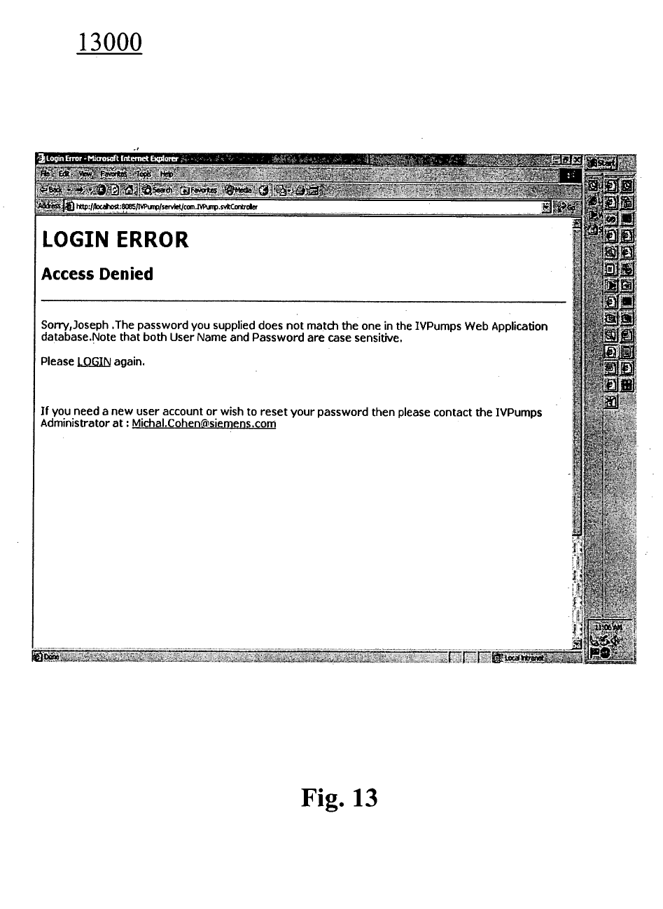

FIG. 13 is a user interface 13000 for a login error associated with a medical device management system. If the login is unsuccessful then the user is presented user interface 13000, which prompts the user to attempt the login process again and provides a link to contact an administrator in the event of repeated difficulty. If there are three unsuccessful attempts to login, then an email is automatically sent to the administrator indicating an unauthorized access attempt.

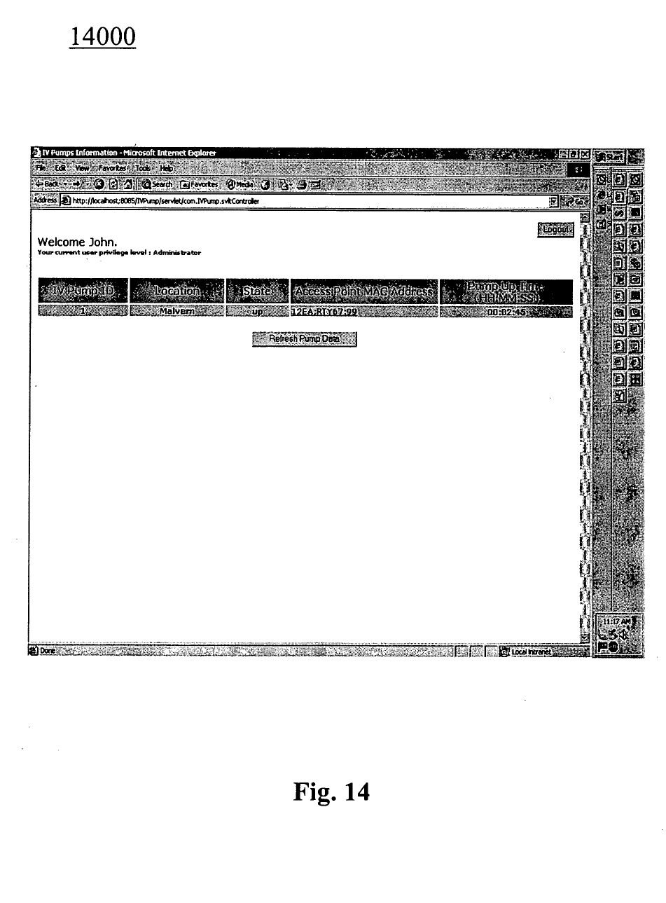

FIG. 14 is a user interface 14000 displaying available pumps. In the event of a successful login, the user is directed to view pump information depending on his administrative privileges or census (chosen during registration and later verified by the administrator). User interface 14000 lets the user view pump information by pump identification; pump location; MAC address of the pump; current state of the pump; an uptime of a pump; MAC address of the access point; etc. As used herein, the term “MAC address” means Media Access Control address, which is a hardware address that uniquely identifies each node of a network. The user can also refresh pump information by pressing the “Refresh Pump Data” user interface button. This button refreshes user interface 14000 in real-time ensuring the user views the most current information in the IVPump SQL server database. The user may logout at any time using a button, or other rendering, provided via user interface 14000.

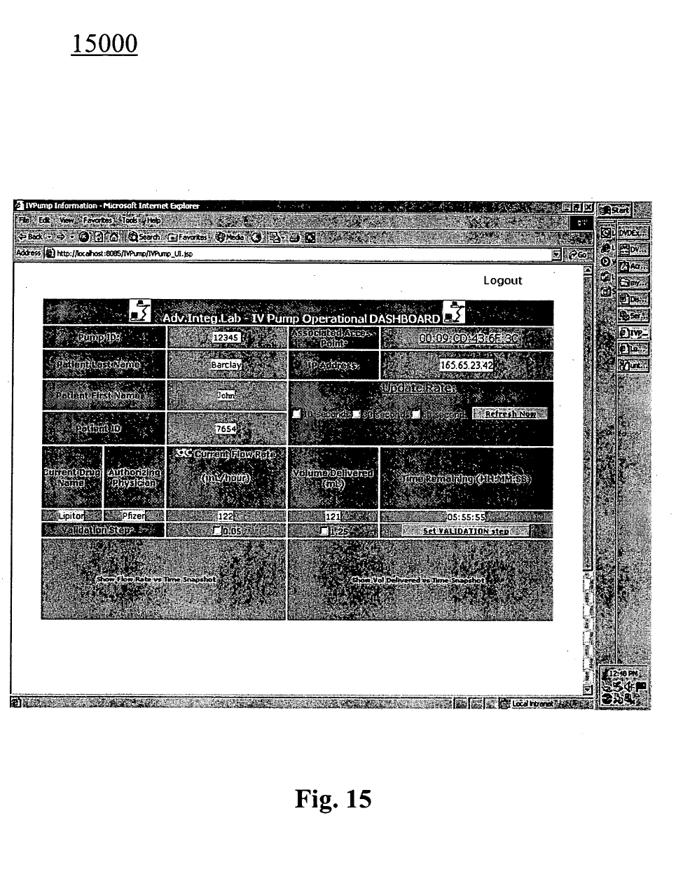

FIG. 15 is an exemplary user interface 15000 for monitoring a pump. The user can view, via user interface 15000, textual and/or graphical information about any particular pump using the link provided under the access point field.

User interface 15000 provides real-time information on “vital statistics” on selected devices and allows administrators to set a validation time and update rate settings, etc. This reporting mechanism has generic applications in healthcare settings and specific application for IV Epidural Pumps.

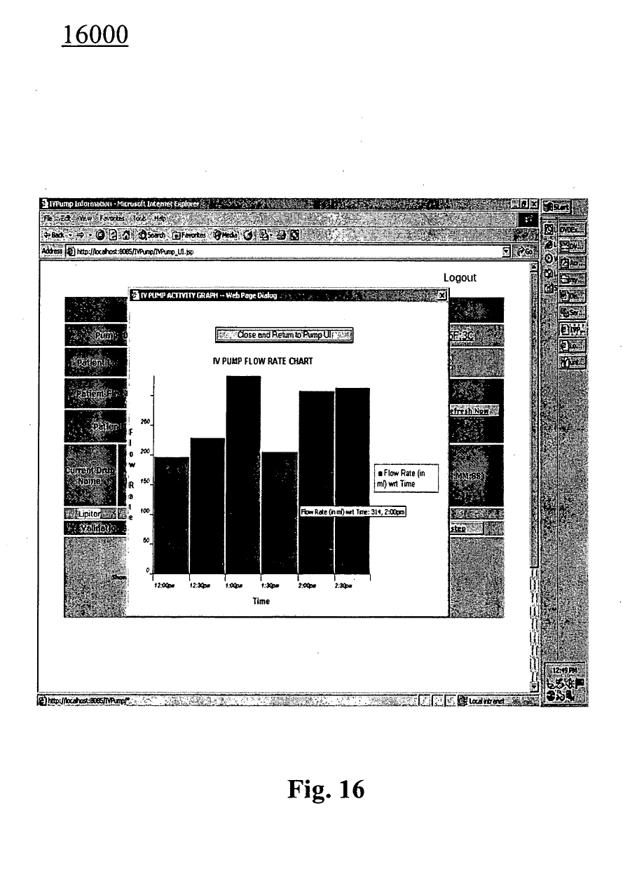

FIG. 16 is a user interface 16000 for monitoring a graphical rendering of pump flowrates. User interface 16000 is activated via, for example, a button, or comparable rendering comprised in a user interface such as user interface 15000 in FIG. 15. User interface 16000 is often rendered as a pop up window. After viewing user interface 16000, the user can close the pop up window using the “Close” button. The users can then logout of the application using the “Logout” button provided.

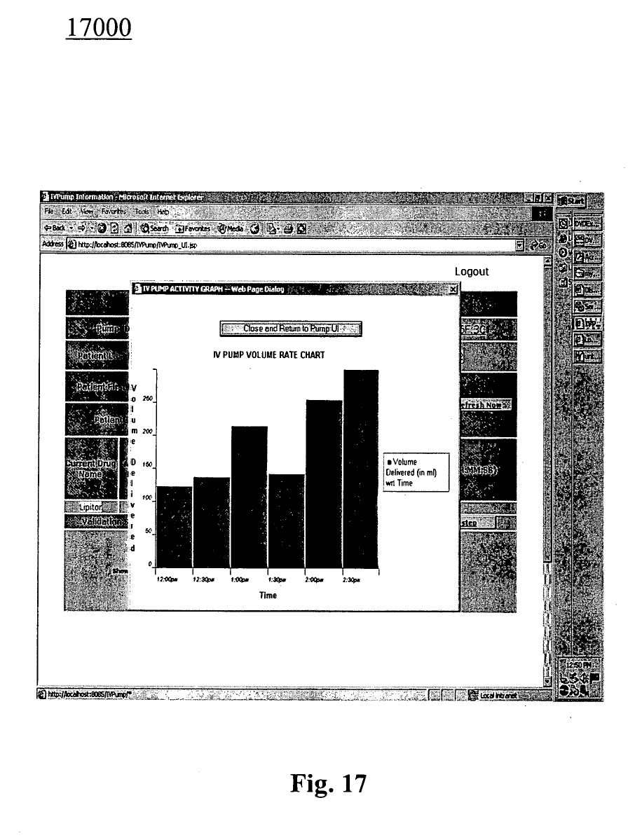

FIG. 17 is a user interface 17000 for graphically displaying pump information. User interface 17000 provides real-time information on flow rates as a function of time for a selected device. This reporting mechanism has generic application for medical devices used in healthcare settings with application for IV Epidural Pumps.

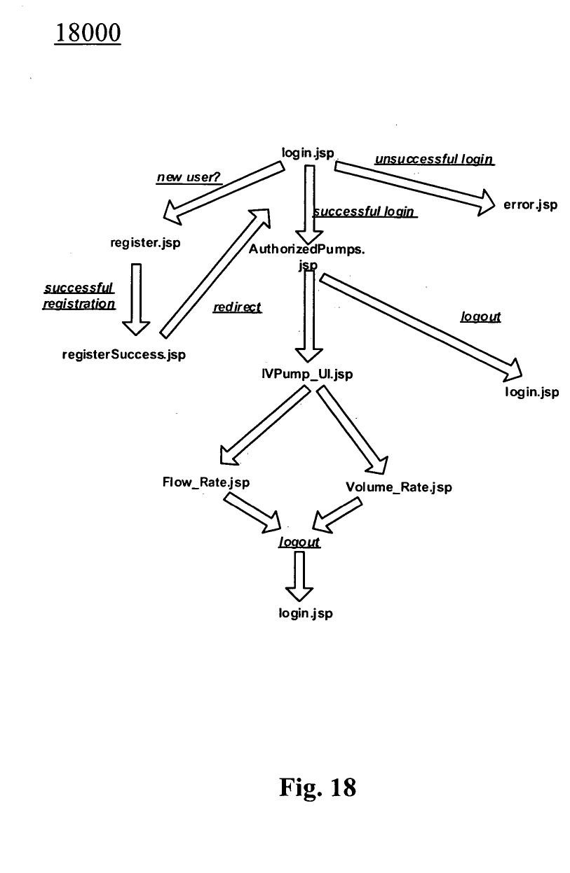

FIG. 18 is a flow logic diagram 18000 for user interface navigation, which shows a sequence of navigation through JSP pages. Flow logic diagram 18000 illustrates exemplary rendering criteria and sequencing for a plurality of JSP pages.

A pump manager's web tier serves HTTP requests. The web tier does four basic things in a specific order: interprets client requests; dispatches those requests to business logic; selects the next view for display; and generates and delivers the next view.

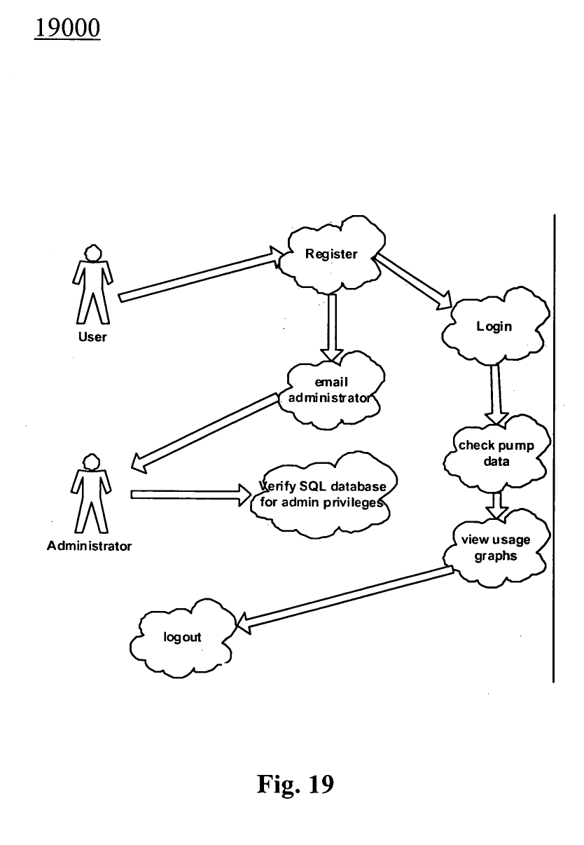

FIG. 19 is an exemplary flow logic diagram 19000 for a medical device management system pump manager application. An early step in enforcing authentication and authorization requires users to authenticate, or prove their identities, in order to access a pump manager set of generic applications. The user may submit information such as a password or a certificate to prove identity. The security system checks the information against a database of known users. If the submitted information matches the information in the database, the user has successfully authenticated.

Certain implementations use the following three levels of security for any user logging in via the Internet: secure sockets layer support; VPN/corporate firewall access; and form based login and password based authentication. As used herein, the term “VPN” means virtual private network, which is a network that is constructed by using public wires to connect nodes. Communications on a VPN are typically encapsulated in a manner so as not to be readable by unintended recipients thereof. The first two are provided by any corporate entity/hospital. The pump manager provides the last and its generic architecture also enables easy integration this with the following levels of security: Microsoft LDAP (the Windows standard for directory enabled networking); Global Session Manager, or GSM (used for authentication and authorization); Sun Java JNDI (Java Native Directory Interface); XML file based authentication (used for security attributes by most commercial application server implementations); and/or biometric (e.g., fingerprints, voice patterns, or DNA); etc.

Other authentication mechanisms can combine these; an example is digital certificates, where key-based (e.g., user name and password, etc.) and knowledge-based (e.g., SSL, etc.) authentication is exercised.

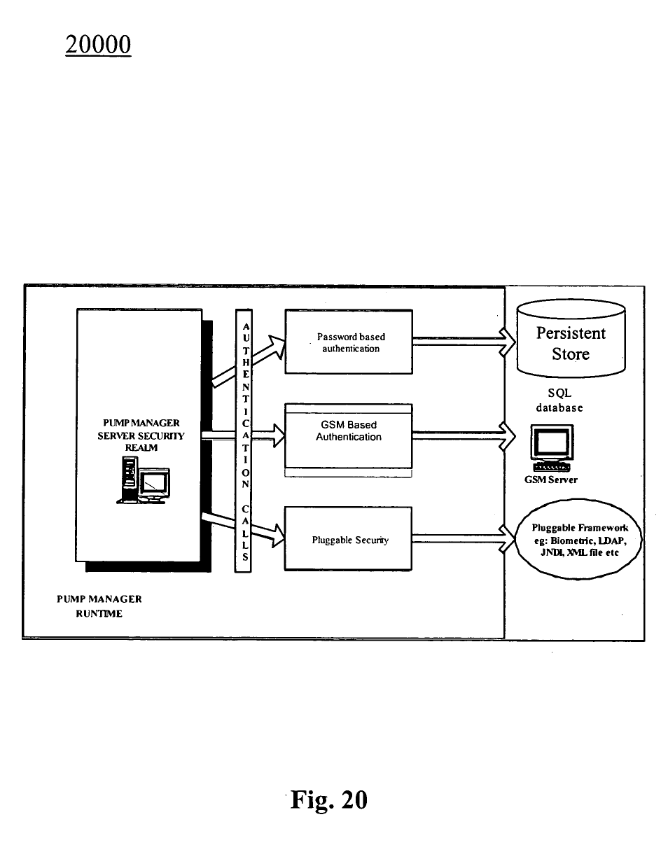

FIG. 20 is a block diagram of a process flow 20000 for authentication in a medical device management system diagram, which illustrates a generic yet pluggable architecture the pump manager uses for security. The pump manager architecture provides for a role based security mechanism that can be configured by choosing the proper and desired user setting at the time of registration. Based on the chosen security level, resources are thus allocated or restricted. A specific group of users may be allowed access to particular pumps such as particular nurses and clinicians associated with particular patients, beds, care units, and/or pumps, etc.

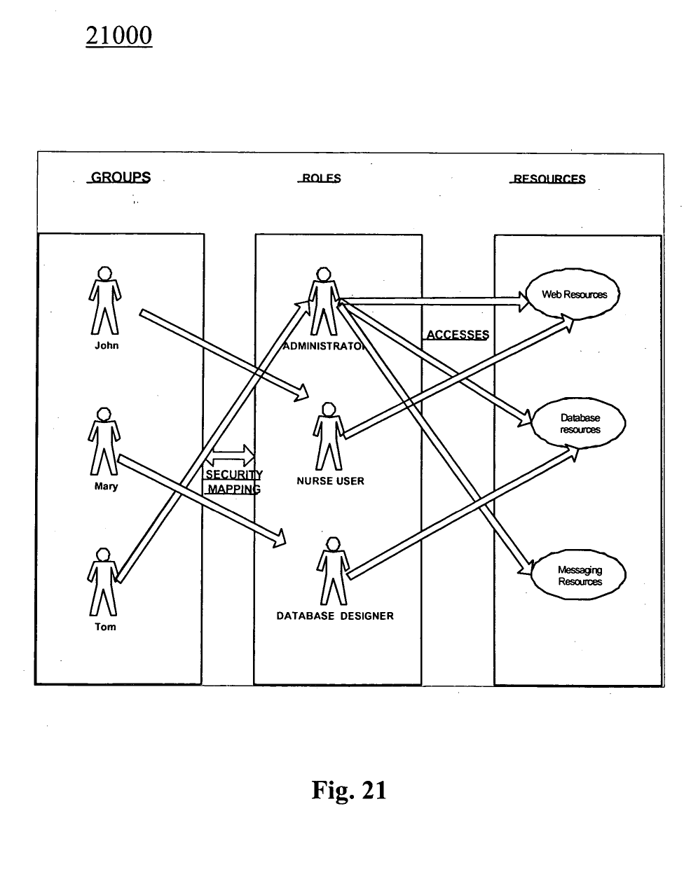

FIG. 21 is a process flow diagram of a security mapping 21000 for a medical device management system. Security mapping 21000 illustrates functional security relationships. Users access secure resources via an authentication and/or authorization process. Users access patient information from Web resources, database resources, and/or messaging resources, etc. An administrator and/or a database engineer implement and/or enforce security policy and mapping.

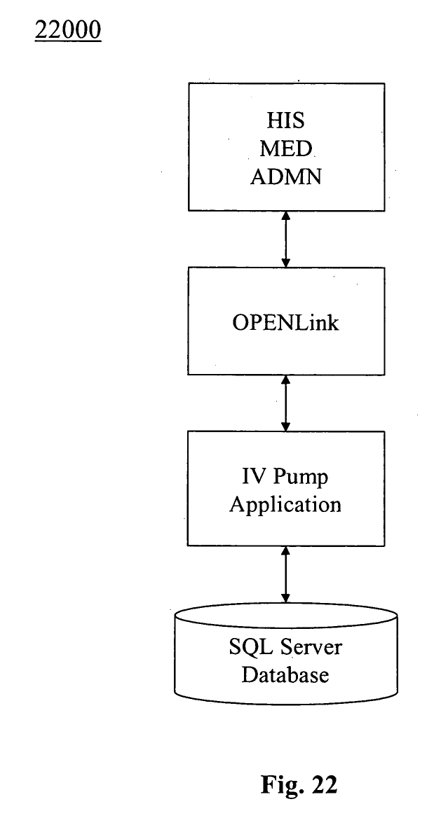

FIG. 22 is a flow diagram 22000 for an open link transaction, which models workflow through an application. Patient demographics are sent from a HIS to the pump manager via OPENLink. Once received by OPENLink demographics data are redirected to IVPump application. The application then processes the request. Validity of the request is checked.

If demographics data are valid, patient name and identifiers are recorded in the database. IV pump system software applications compose an acknowledgment message and send the message through OPENLink to an originating system.

Flow diagram 22000 comprises two OPENLink interfaces: one for an outbound interaction and one for an inbound interaction. The inbound interaction sends information to a pump application. Outbound interaction sends information from the pump application.

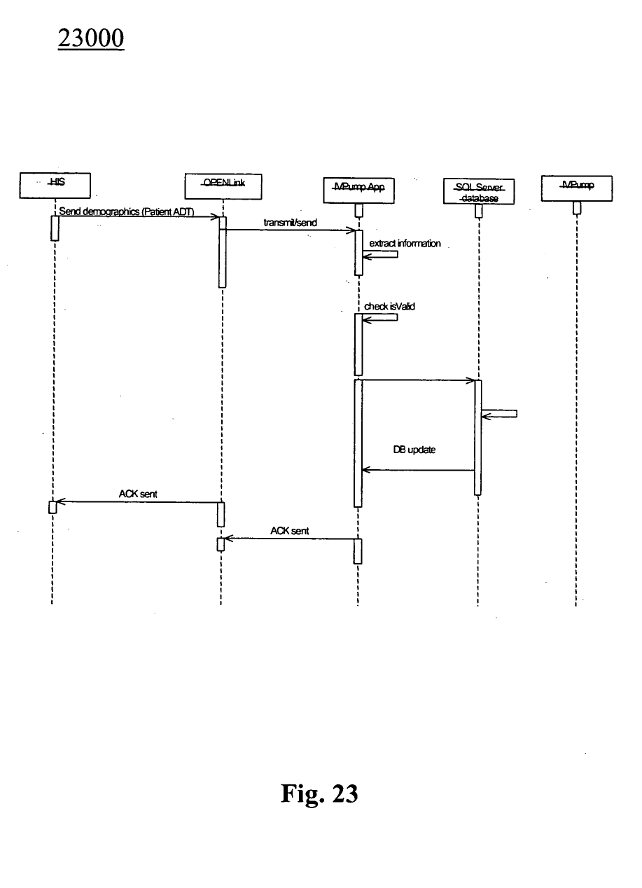

FIG. 23 is a process diagram 23000 for a data transmission to a pump manager, which shows a sequence of a successful demographics event. Data obtained via a user interface originates the event. The information is checked for validity and then stored in a SQL server database. In this case, the pump is not affected and continues in its current mode.

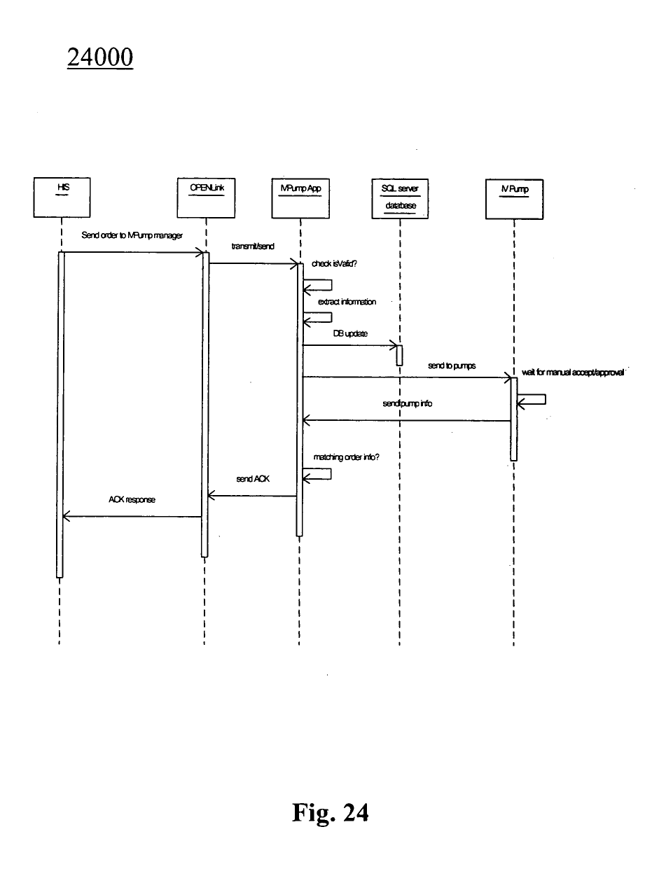

FIG. 24 is a process diagram 24000 for an order sent to a pump manager, which shows a successful order transmission event. The order comprises information specifically dealing with running/operation of the pump. If a valid patient identifier and/or name are recorded in a database then an order associated with that patient is accepted by the IV pump manager for update within the database.

Transactions processed via process diagram 24000 as a valid demographics event need to be in an HL7 standard format with required fields filled out. A method for controlling duplication is incorporated in the application. A duplication method prevents duplicate information from being entered to the database.

Transactions processed via process diagram 24000 as valid orders are in an HL7 format that follows ORC syntax. The Common Order segment (ORC) is used to transmit fields that are common to orders (types of services that are requested). The ORC syntax is a standard syntax employed within HL7 orders (inclusive of Pharmacy, Dietary, for example). Demographic information (such as patient name, patient ID etc.) is stored in a database in order to be used as a validation mechanism. For example, an order to a specific patient that is associated with a specific pump cannot be transmitted to a different pump.

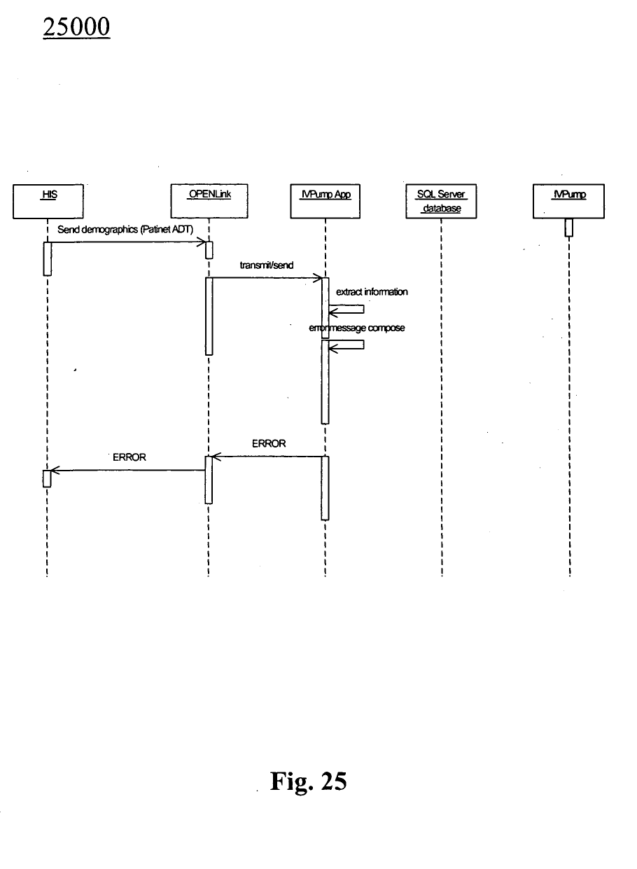

FIG. 25 is a process diagram 25000 for an invalid order sent to a pump. Process diagram 25000 illustrates that invalid order information does not affect information stored in the database. An error message is sent back to an order originator. Process diagram 25000 also applies to a scenario wherein an invalid order is sent to the pump manager. The information does not affect the running of the pump. An error message is sent back to a sending system originator.

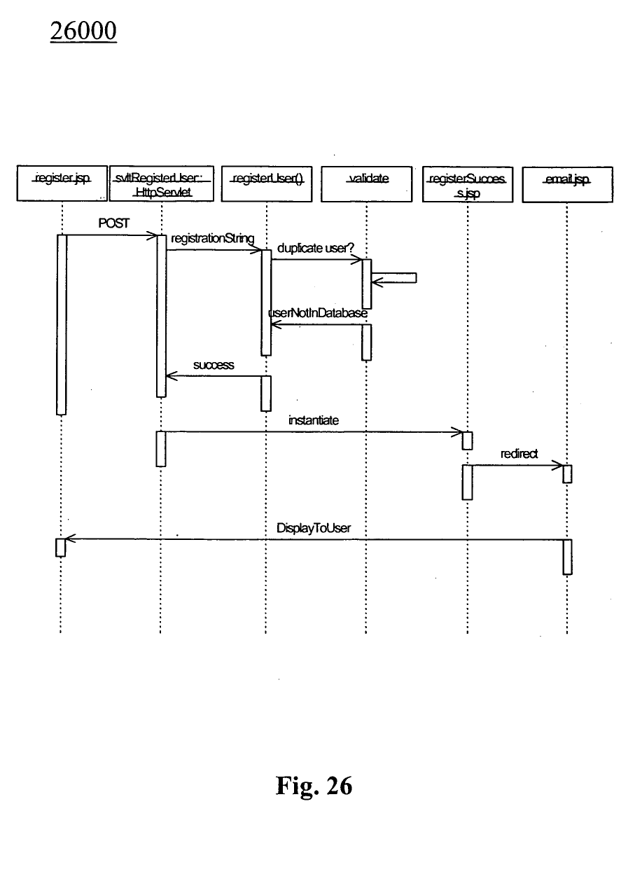

FIG. 26 is a process diagram 26000 for a successful registration in a medical device management system. The user registers supplying his credentials and clicking submit on a register.jsp page. A request for verification is then sent to the Servlet svltRegister, which then checks the database, using a registerUser ( ) method, to see if there is a duplicate username. If so, then a registration error page is rendered wherein the user is urged to try to register again. If the registration is successful, then the user is directed to login.

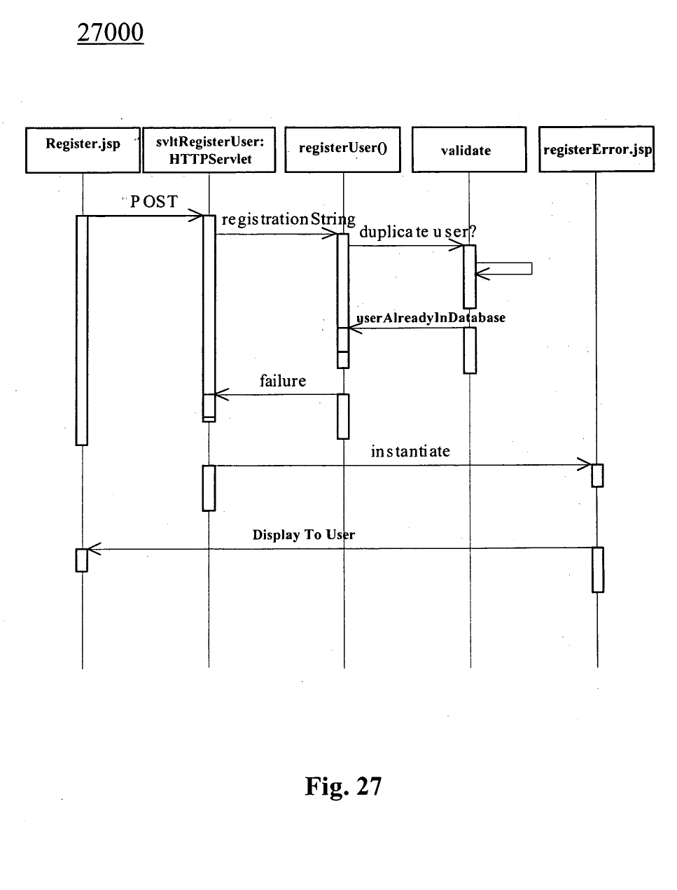

FIG. 27 is a process diagram 27000 for a failed registration in a medical device management system, wherein the user registers supplying credentials and directs the submission of the credentials by selecting an icon such as a submit button on a register.jsp page. The post is then sent to the Servlet svltRegister, which then checks the database, using the registerUser ( ) method, to see if there is a duplicate username. If a duplicate username is found, then a registration error page is rendered and the user is urged to try to register again.

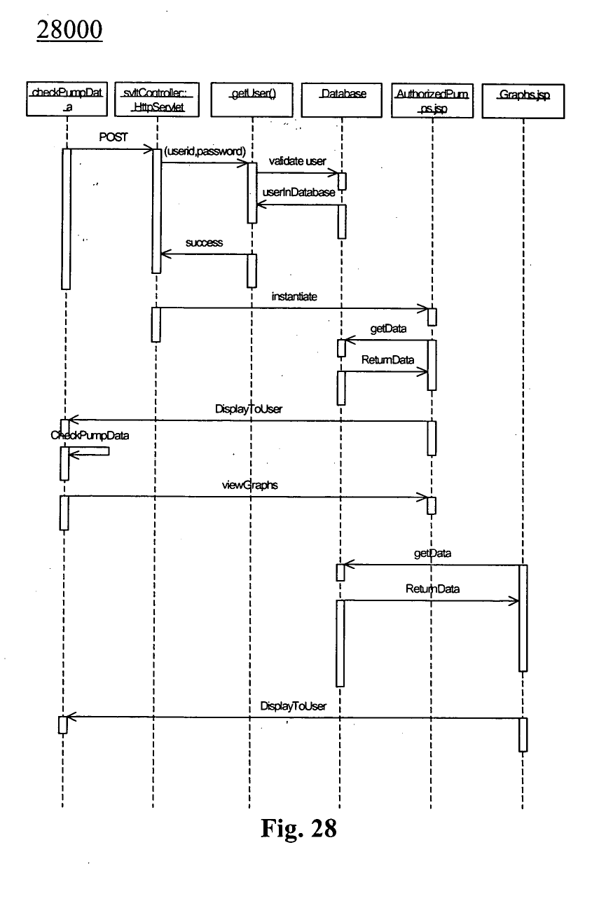

FIG. 28 is a process diagram 28000 for a device data check by an authorized user.

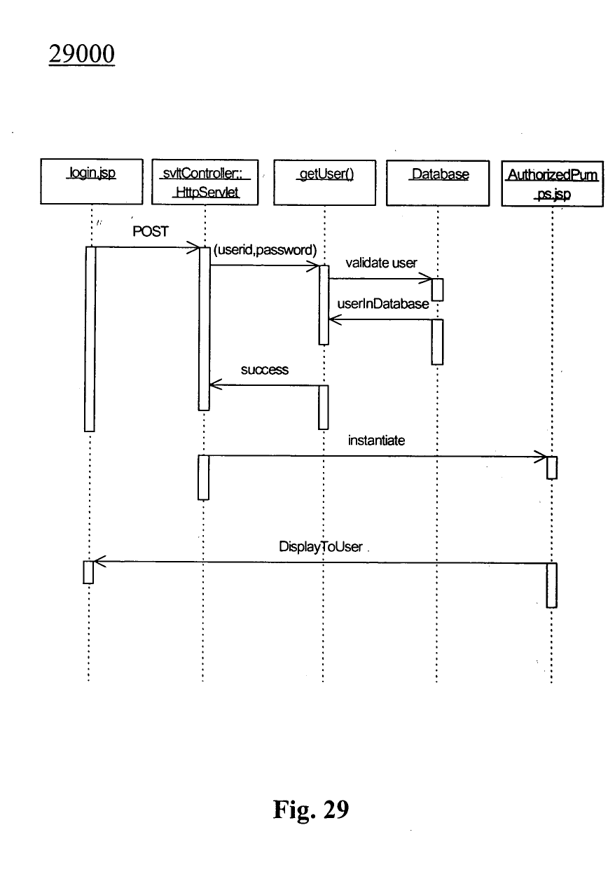

FIG. 29 is a process diagram 29000 for successful login to a medical device management system, wherein the user registers by supplying credentials and directing the submission of the credentials by selecting an icon such as a submit button on a login.jsp page. The post is then sent to the Servlet svltController, which then checks a database, using the getUser ( ) method, to see if there is a match. If the information indicates that the user is registered, then the user is allowed to login.

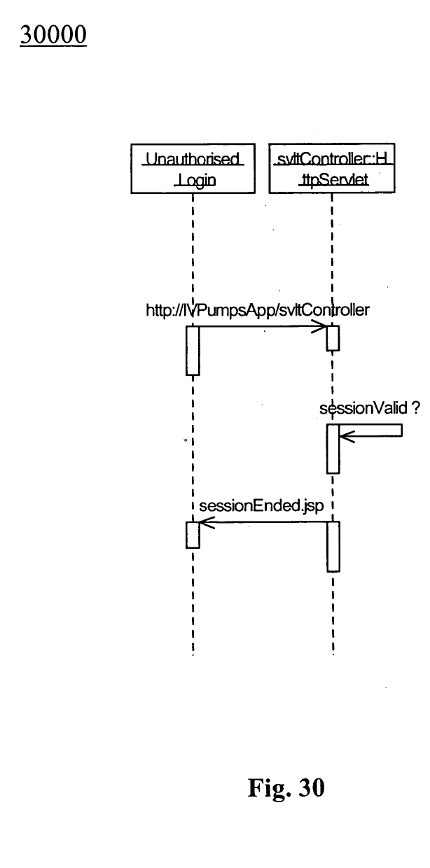

FIG. 30 is a process diagram 30000 for an unsuccessful attempt to open a session without logging in, wherein the user directly types in the name of the Servlet controller in the browser's address window. The svltController, using session tracking knows that the user is not in session. The user is redirected to an error page.

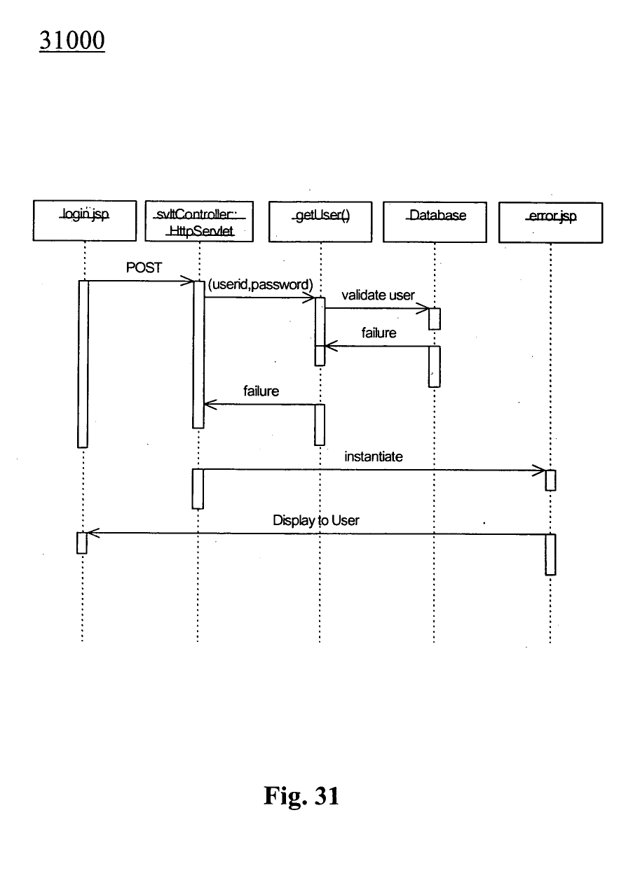

FIG. 31 is a process diagram 31000 for an unsuccessful login, wherein the user registers supplying his credentials and clicking Submit on the login.jsp page. The POST is then sent to the Servlet svltController, which then checks the database, using the getUser ( ) method, to see if there is a match. If user is not authorized, then an error page is rendered and the user urged to make another attempt to login.

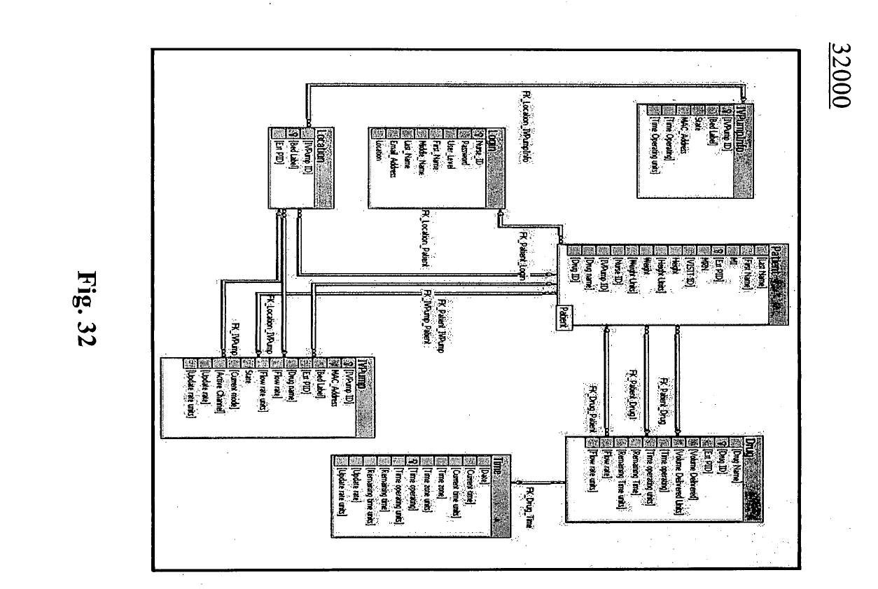

FIG. 32 is a block diagram of a database schema architecture 32000, which comprises a plurality of tables comprising information regarding IV pumps, patients, drugs, user login, location, and/or time, etc. The IV pump information table comprises a pump ID, bed identifier, status, MAC address, operating time, patient identifier, drug name, flow rate, mode, channel, update rate, and/or update units, etc. In database schema architecture 32000, IV pump information is divided into two tables. The patient table comprises a last name, first name, middle initial, patient identifier, medical record number, visit identifier, height, height units, weight, weight units, nurse identifier, IV pump identifier, drug name, and/or drug identifier, etc.

The drug table comprises a drug name, drug identifier, patient identifier, volume delivered, units for delivered volumes, operating time, operating time units, remaining time for a particular medication administration, units of remaining time, flowrate, and/or units of flowrate, etc. The user login table comprises a nurse identifier, password, user level, first name, middle name, last name, e-mail address, and/or location, etc. The location table comprises an IV pump identifier, bed label, and/or patient identifier, etc. The time table comprises a date, current time, current time units, time zone, time zone units, operating time, operating time units, remaining time, remaining time units, update rate, and/or update rate units, etc.

Table II provides detail of a database schema for a medical device management system. Records for the database schema comprise:
patient: holding patient information that is linked to a specific medical device;
medical device: holding medical device information;
drug: holding drug information to be administered via the medical device;
time: holding time attributes for a medical device application;
location: holding information related to the whereabouts of the medical device; and
login: holding information regarding authorized users and associated pumps.

Each table comprises more than one field. Fields within records, as indicated in Table II, are prenamed and predefined. Fields have a predetermined format. Fields are used to accept, store, transfer, and/or render data.

TABLE II

| Table | | |
|---|---|---|
| Name | Function | Attributes |
| Patient | The table holds | Last_Name, First_Name, MI, Ext_PID, MRN, |
| | patient information | VISIT_ID, Height, Height_Units, |
| | that is linked to a | Weight, Weight_Units, |
| | specific IVPump | Nurse_ID, IVPump_ID, Drug_name, Drug_ID |
| IVPump | The table holds | IVPump_ID, Bed_Lable, Ext_PID, Drug_name, |
| | IVPump information. | Flow_rate, Flow_rate_Units, State, Current_mode, |
| | | Active_Channel, Update_rate, Update rate units |
| Drug | The table holds Drug | Drug_Name, Drug_ID, Ext_PID, |
| | information that is | Volume_Delivered, Volume_Delivered_Units, |
| | being transfused | Time_operating, Time_operating_units, |
| | through an IVPump | Remaining_Time, Remaining_Time_units, |
| | | Flow_rate, Flow_rate_units |
| | | Dosage, Dose_Units, Concentration, |
| | | Concentration_Units |
| Time | The table hold several | Date, Current_time, Current_time_units, |
| | time attributes for the | Time_zone, Time_zone_units, Time_operating, |
| | IVPump Application | Time_operating_units, Remaining_time, |
| | | Remaining_time_units, Update_rate, |
| | | Update_rate_units |
| Location | The table provide | IVPump_ID, Bed_Label, Ext_PID |
| | information on the | |
| | whereabouts of the | |
| | IVPump | |
| Login | The table holds the | Nurse_ID, password, User_Level, First_Name, |
| | information for | Last_Name, Email_Address, Location |
| | authorized users and | |
| | associated pumps | |

Using Tomcat, a medical device web application is built, packaged, and/or deployed. Deployment steps comprise creating the web application directory structure, creating a web application ServletContext, adding JSPs and Servlets, adding tag libraries, and/or creating and deploying a WAR file, etc. These steps are easily extensible to any medical device application that follows the architecture of the medical device management system.

Table III illustrates a web application directory structure for a medical device management system. The directory structure comprises a plurality of directories and subdirectories for storing web pages, web page resources, utilities, and/or archive files, etc.

TABLE III

| Directory | Contains |
|---|---|
| /IVPump | This is the root directory of the web application. JSP and |
| | HTML files are stored here. |
| /IVPump/ | This directory contains resources related to the application that |
| WEB- | are not in the document root of the application. This is where |
| INF | the IVPump web application deployment descriptor is located. |
| | Note that the WEB-INF directory is not part of the public |
| | document. No files contained in this directory can be served |
| | directly to a client. |
| /IVPump/ | This directory is where Servlet and utility classes are located. |
| WEB- | |
| INF/ | |
| classes | |
| /IVPump/ | This directory contains Java Archive files that the Pump |
| WEB- | Manager web application depends upon. For example, this is |
| INF/lib | where you would place JAR files that give us jsp taglib and |
| | Java mail support. |

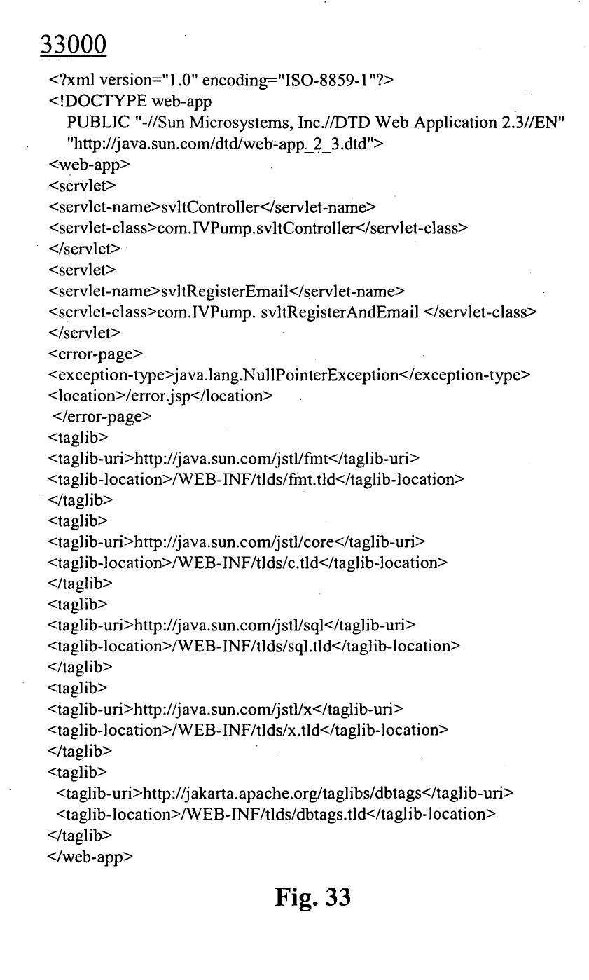

FIG. 33 is a section of XML code 33000 associated with controlling a device in a medical device management system. A step in creating the web application directory structure is adding a deployment descriptor. Section of XML code 33000 is copied to a director such as a TOMCAT_HOME/IVPump/WEB-INF/directory. After creating the web application directory structure, a new ServletContext is added to Tomcat. The ServletContext defines a set of methods that are used by components of a web application to communicate with the Servlet container. The ServletContext acts as a container for the web application. There is only one ServletContext per web application.

To add a new ServletContext to Tomcat an entry is added to a file such as a TOMCAT_HOME/conf/server.xml file, setting the values for the path and docBase to the name of the web application, such as an IVPump application. The entry is thus: <Context path=“/IVPump” docBase=“IVPump” debug=“0” reloadable=“true”/>.

The first, path=“/IVPump”, tells the Servlet container that requests with /IVPump appended to the server's URL belong to the IVPump web application. The second, docBase=“IVPump”, tells the Servlet container that the web application exists in the/IVPump directory.

Steps for adding Servlets and JSPs comprise placing JSP pages directly under a WEB-INF folder, compiling Servlets, and/or moving Servlets into a directory such as the /IVPump/WEB-INF/classes/com/IVPump directory, etc.

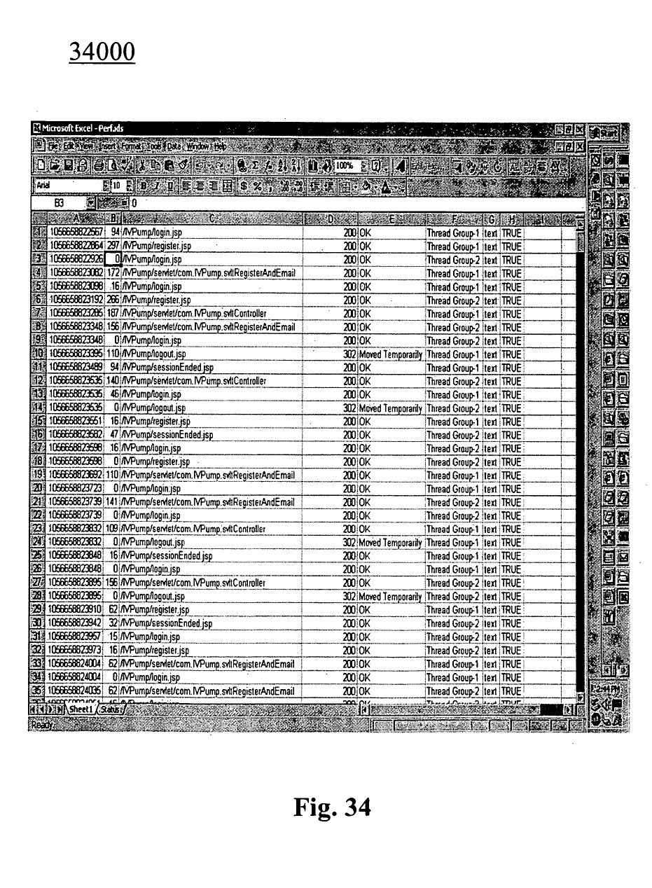

FIG. 34 is an exemplary user interface 34000 for rendering stress test results associated with a medical device management system, Apache JMeter has been used to load test the medical device manager application. User interface 34000 represents a tabular representation that, with other Jmeter data, in actual testing, while running on a Pentium 4, 1.3 GHz PC with 256 MB RAM, handled 10 simultaneous active users with a maximum response time of 297 milliseconds and handled a peak load of 40 users with a 23% degradation in response time.

Software used in running the medical device application comprises: a JSP/Servlet implementation can be run as a standalone or as an extension to a web server (in a test embodiment, Tomcat 4.0.3 was used since the standard Tomcat tag libraries are used extensively, the application is in some way tied to Tomcat); an SMTP mail server, this is optional but since the application usually uses a corporate intranet, it is reasonable to expect this; Microsoft SQL Server is recommended as a relational database management system (other embodiments of the medical device manager can use MySQL as a database engine); and/or Apache Jmeter has been used to load test the application; etc.

As used herein “JSTL” means, JavaServer Pages Standard Tag Library, which encapsulates as simple tags core functionalities common to many Web applications. JSTL has support for common, structural tasks such as iteration and conditionals, tags for manipulating XML documents, internationalization tags, and SQL tags. JSTL also provides a framework for integrating existing custom tags with JSTL tags. As used herein, the term “Jakarta Struts” means an open source framework for building Java web applications. The Struts framework comprises a control layer based on technologies like Java Servlets, JavaBeans, ResourceBundles, and XML.

A clinical context object workgroup (“CCOW”) is a standard that specifies architectures, component interfaces, and data definitions as well as interoperable technology-specific mappings of these architectures, interfaces, and definitions. Using CCOW, multiple applications can be automatically coordinated and synchronized at a point-of-use. Specified architectures establish a basis for bringing interoperability among healthcare applications to a point-of-use. A JBOSS application server is a Java 2 Enterprise Edition application server with EJB support.

Considerations in creating a system comprise: providing a registration module (such a's a Web application) comprising a user interface (such as a user interface that uses XML messaging, rather than an HTML Web browser); using JSTL instead of Java Beans can be a performance bottleneck in the event of multiple users logging in at the same time; a MVC framework like Jakarta Struts; integrating with GSM, or, CCOW; and/or an Open Source EJB container like a Jboss Application server, or an HIS Application Server along with Apache Tomcat at the web layer; etc.

Table IV illustrates a total IV pump inventory and associates specific infusion pumps with particular room locations and patient identifiers (PID/MRN=patient identification/medical record number) within specific units in the enterprise. The information carried by the RFID tag (patient identifier and local pump internet protocol address, for instance) uniquely defines the pump association with a particular patient. Thus, a pump can be located quickly by way of such a view. This view can be generated quickly via scripts and displayed within a Web browser.

TABLE IV
IV Pump Inventory: 50

| | Unit: 5-West | Pumps in use: 10 |
|---|---|---|
| Room/POD | MAC/IP Address | PID/MRN |
| 5W101 | 00-30-F1-35-54-D8 | 400336 |
| 5W102 | 31-67-G3-67-23-A1 | 844179 |
| . | . | . |
| . | . | . |
| . | . | . |
| 5W110 | 98-H2-45-89-01-J4 | 143582 |
| | Unit: ICU-1 | Pumps in use: 20 |
| Room/POD | MAC/IP Address | PID/MRN |
| ICU1101 | 89-32-54-69-B4-19 | 903512 |
| . | . | . |
| . | . | . |
| . | . | . |
| ICU1120 | 90-11-D7-76-A8-18 | 796380 |
| | Unassigned Inventory: 12 | |
| | In Maintenance: 8 | |

The medical device system information provides feedback to a pharmacy entity on the location of monitored devices within the enterprise and/or the proximity of a particular pump to the pharmacy entity. For example, as patients arrive or leave, are administered intravenous fluids on pumps, and/or removed from pumps; a rendered user interface is updated.

Information regarding unassigned medical devices allows a clinician ordering drips for a patient to determine a quantity of pumps available for use, and those that are active within an enterprise. Information regarding unassigned medical devices also provides useful information for managing maintenance on previously active pumps to prepare those pumps for use on future patients.

When an order is placed for an application using a medical device, a particular medical device can be assigned with the order (e.g., a pump identifier is carried with the electronic order). The medical device is associated with a patient and is managed by at least one clinician. An identifier, such as a unique serial identification associated with that medical device, is communicable via a wireless network adapter then provides a way to manage and know both the location of the medical device and the patient; the location of a particular patient with respect to an assigned medical device; whether that medical device is experiencing malfunction (moved to maintenance) or whether administered medication is running low; and/or whether the medical device is in need of general maintenance.

Orders assigned to a particular medical device have location and identifiers associated with them so that the pharmacy can ascertain without ambiguity the location and patient assigned to any pump.

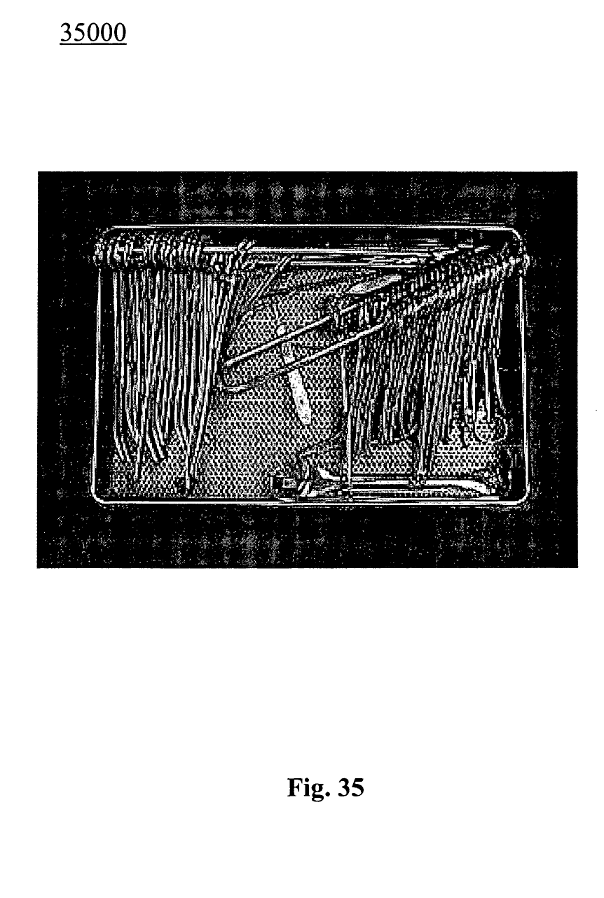

FIG. 35 is an exemplary surgical tray 35000 identifiable and trackable by a medical device management system. Scheduling operating rooms for surgical procedures involves linking clinical orders with scheduling entities. Ordering a surgical procedure translates into a number of requests for resources: available staff, available theatre on a particular day and time, and/or equipment that must be brought in to support a particular procedure, etc. One piece of equipment that is tracked and must be prepared and scheduled for surgery is surgical tray 35000. An RFID tag can be associated with surgical tray 35000 to track surgical tray 35000 as part of an inventory (contents of surgical tray 35000 vary depending on the type of surgery being performed).

Therefore, using an RFID tag in cooperation with a Web manager (application different from medical devices) has benefits from the perspective of being able to locate inventories of surgical trays, such as surgical tray 35000; having specific information as to the whereabouts of a particular tray, such as surgical tray 35000; and/or having specific information as to the location of a patient upon which surgery is to be performed; etc. In this way, a surgical order specifies the need for a particular type of surgical tray 35000 together with the time and operating theatre into which surgical tray 35000 should be delivered. Thus, surgical tray 35000 can be delivered to the operating theatre and segregated offline before patient surgery so that they are not misappropriated or valuable time is not wasted in the process of attempting to locate surgical tray 35000. The RFID tag is typically applied directly to the surgical tray 35000 (the underside, for instance).

Radio frequency identification tags (RFIDs), implemented as both passive and active types, retain specific information regarding their associated objects (specifically, identifiers of devices, patients, etc.). Passive RFID tags do not have their own power supply: the minute electrical current induced in an RFID antenna by the incoming radio-frequency scan provides enough power for the tag to send a response. Due to power and cost concerns, a response of a passive RFID tag is necessarily brief, typically just an ID number (GUID). Active RFID tags comprise a power source, and may have longer ranges and larger memories than passive tags, as well as an ability to store additional information sent by a transceiver.

Attaching RFID tags allows devices (infusion pumps, patient monitors, etc.) to be managed and tracked. For example, the following table illustrates a view that can be managed through a medical device (such as an IV pump) Web manager interface that shows the quantity of medical devices in use in specific units and rooms within an enterprise.

A mechanical ventilator for respiratory support is often employed within intensive care units. Mechanical ventilation is normally ordered for patients who cannot sustain spontaneous respiration and therefore require assistance in breathing. Many types of patients require assistance in this manner, one type being a coronary bypass-grafting patient. The use of the mechanical ventilator requires that a physician order its use for a particular patient. These orders translate into locating a mechanical ventilator within the room of a patient, sometimes in preparation for patient arrival. Locating mechanical ventilators for use within an enterprise can benefit from the use of RFID tags in concert with a management system for associating the location of the mechanical ventilator with a particular patient. The RFID tag can be attached directly to the ventilator's exterior. Once programmed with a unique identifier (the serial number of the ventilator, for instance) the data can be transmitted to the Web-based application (transaction manager) and associated with a particular patient. In this way, the medical device management system: tracks the location of the ventilator; associates ordered changes on a particular patient (identified by patient medical record number or external identifier) positively with a particular ventilator; maintains an audit trail within the patient's clinical record as to which specific ventilator was employed during therapy (for the purpose of quality control and for legal reasons should a patient experience complications post-extubation); and/or to verifies the settings of the mechanical ventilator with the physician order by way of validating the specific ventilator settings available through a care system with the patient identifier, and then associating the identifier with the mechanical ventilator, etc. An auditing trail can be used also for quality control to ensure that a physician's orders were carried out on a specific ventilator at a specific time (feedback on a clinical order).

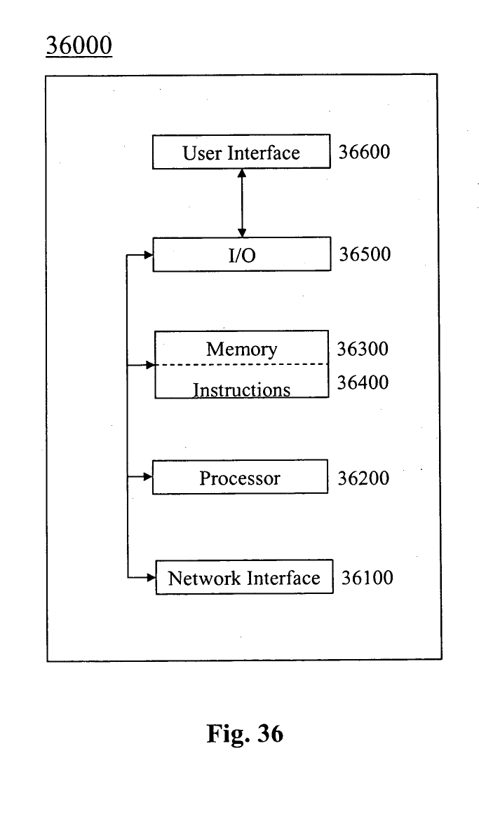

FIG. 36 is a block diagram of an information device 36000, which comprises, for example, information device 1200 and/or server 1100 of FIG. 1. Information device 36000 comprises any of numerous well-known components, such as for example, one or more network interfaces 36100, one or more processors 36200, one or more memories 36300 containing instructions 36400, one or more input/output (I/O) devices 36500, and/or one or more user interfaces 36600 coupled to I/O device 36500, etc. Via one or more user interfaces 36600, such as a graphical user interface, a user can view a rendering of information related to the use and/or management of a medical device.

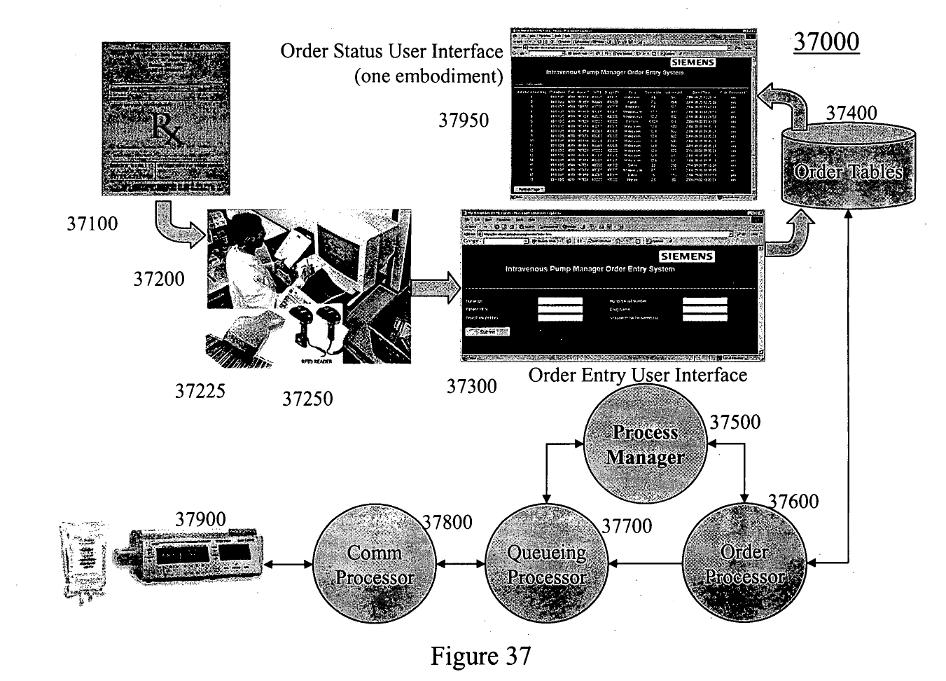

FIG. 37 is a block diagram for a medical device management system 37000, which depicts major functions performed by an IV pump manager in support of order processing.

A prescription 37100 arrives at a pharmacy where a pharmacist, as illustrated at 37200, processes prescription 37100 and prepares drugs and intravenous medications to be delivered to the patient via an IV pump 37900.

Medications and intravenous fluid bags are tagged by the pharmacist at 37200 with patient, ordering clinician, and drug identifying information. This information is stored in the form of barcode labels and/or RFID tags created by pharmacy processing software.

During the prescription fulfillment process, the pharmacist transmits identifying information to a point of care using (in one embodiment), at 37300, an order entry user interface that can receive: data provided manually by the pharmacist, data provided via a network in a non-scanned barcode format, and/or data provided via a barcode scanner (at 37225) and/or radio frequency tag reader (at 37250).

Medication, patient, and device identifying information are stored within order tables of an IV pump manager database at 37400.

At 37600, IV pump manager order processor, directed and monitored by IV pump manager process manager 37500, continuously polls and retrieves new order information from order tables 37400.

Queuing processor 37700 receives new orders from order processor 37600 and extracts from orders specific patient and IV pump identifying information. Process manager 37500 continuously updates the queuing processor 37700 as to individual IV pump profile changes (i.e., changes in alert status, pump polling attempts, valid pumps, etc.)

Queuing processor 37700 communicates an appropriately formatted message to communications processor 37800, which attempts to transmit a message to a patient-specific IV pump 37900.

Communications processor 37800 communicates with IV pump 37900 using standard network protocols (typically wired or wireless communication via TCP/IP protocol transmission).

Communications processor 37800 notifies queuing processor 37700 in the event that (i) network communication cannot be established with IV pump 37900, (ii) IV pump 37900 is not responding to a properly formatted transmission, (iii) IV pump 37900 is not in the correct state to receive a transmission, and/or, (iv) IV 37900 pump has acknowledged receipt of the transmission.

Upon receipt of one of these messages, queuing processor 37700 communicates with the process manager 37500, informing it of either successful or unsuccessful transmission, and as to the reason in the case of unsuccessful transmission. Process manager 37500 provides a notification message that is made available to the pharmacist and the clinician. Process manager 37500 communicates this notification message through order processor 37600 to order tables 37400.

Once the notification message is stored within order tables 37400, the notification message is available for transmission to any number of recipients. One embodiment of this notification is through an order status user interface 37950 that provides a tabular status of every order, when the order was transmitted, when the order was accepted by IV pump 37900, and whether the order has been executed at the point of care (i.e., a clinician has confirmed acceptance of the order).

Queuing processor 37700 maintains a list of common orders to pumps and attempts in round-robin fashion to re-transmit orders to pumps for which previous attempts have been unsuccessful. The total number of attempts and the duration over which queuing processor 37700 attempts re-transmissions are dictated by a profile managed by process manager 37500.

Queuing processor 37700 can assist with the logistics of transmitting a fulfilled order from a pharmacy to IV pump 37900 at the point of care. Physically, a pharmacist and a particular IV pump are not likely to be co-located. Queuing processor 37400 eliminates a need for a clinician and a pharmacist to coordinate transmission of an order to the point of care at the same time. The queuing processor 37700 provides both the pharmacist and the clinician with the flexibility to act and respond asynchronously to a transmitted order, without risking the loss of information or requiring a pharmacist to manually re-transmit the order to the bedside. Instead, the pharmacist transmits the order and the fulfillment of that order occurs later (within clinically acceptable time limits) to allow for clinician notification of the transmission and relocation to the bedside. Queuing processor 37700 “waits” for the clinician and allows the clinician to reach the appropriate IV pump so that the pump can be directed to receive the in-bound order.

Still other embodiments are readily apparent to those skilled in this art from reading the above-recited detailed description and drawings of certain exemplary embodiments.

1. An information system for managing operation of medical devices in delivering treatment to a patient, comprising:
an order processor for processing a physician order for initiating providing a treatment to a patient;
a device management processor for receiving data items from said order processor comprising at least one of,
(a) a patient identifier and
(b) an identifier for identifying said physician order,
and for processing and using said data items in managing access to a medical device used for delivering said treatment to said patient, wherein said device management processor associates at least one registered user with said medical device, and wherein said device management processor is adapted to register an unregistered user; and
a communication interface enabling bidirectional communication between said device management processor and said medical device.

2. An information system according to claim 1, wherein
said patient identifier comprises non-scanned fixed format barcode.

3. An information system according to claim 1, including
said device management processor uses at least one data item of said data items in configuring said medical device for delivering said treatment to said patient.

4. An information system according to claim 1, including
said device management processor uses at least one data item of said data items in at least one of, (a) interrogating said medical device for status information, (b) testing said medical device, (c) determining a location of said medical device, (d) determining access to said medical device is authorized and (e) performing a safety check to determine whether it is safe to initiate said treatment using said medical device.

5. An information system according to claim 1, wherein
said medical device comprises at least one of, (a) an infusion pump, (b) a ventilator, and (c) a patient monitoring device.

6. An information system according to claim 1, including
said managing access to said medical device comprises managing access to information concerning said medical device.

7. An information system according to claim 1, including
an authentication processor for receiving user identification information and for determining a user is a member of a predetermined group of authorized users permitted to access information concerning said medical device and inhibiting access to said medical device information in response to a determination that access is unauthorized.

8. An information system according to claim 6, including
a tracking processor for recording at least one of, (a) user identification information and (b) data identifying medical device information accessed, in response to user access to said information concerning said medical device.

9. An information system according to claim 1, including
a repository including patient specific information wherein
said device management processor uses said received data items and said patient specific information in said repository for determining whether it is safe to use said medical device for delivering said treatment to said patient.

10. An information system according to claim 1, wherein
said device management processor receives data items from said order processor in a message of predetermined format having predetermined data fields and
said device management processor determines whether it is safe to use said medical device for delivering said treatment to said patient based on an absence of required data in a predetermined data field of said message of predetermined format.

11. An information system according to claim 10, wherein
said message of predetermined format having predetermined data fields comprises a HealthLevel 7 (HL7) compatible message.

12. An information system according to claim 1, wherein
said device management processor receives data items including patient specific healthcare related information from said order processor and
said device management processor determines whether it is safe to use said medical device for delivering said treatment to said patient using said patient specific healthcare related information.

13. An information system for managing operation of medical devices in delivering treatment to a patient, comprising:
an authentication processor for receiving user identification information and determining a user is authorized to access an application used in managing a particular medical device used for delivering a treatment to a patient and inhibiting access to said application in response to a determination access is unauthorized;
a device management processor for receiving data items in a message of predetermined format having predetermined data fields and for processing said data items in managing operation of said particular medical device, in response to a user authorization determination, wherein if said user is registered, said device management processor associates said user with said medical device, and wherein said device management processor is adapted to register said user if said user is not registered; and
a communication interface enabling communication of said device management processor with said medical device.

14. An information system according to claim 13, wherein
said message comprises a non-scanned fixed format barcode identifier.

15. An information system according to claim 13, wherein
said data items include,
(a) a patient identifier,
(b) an identifier for identifying a physician order associated with said particular medical device used for delivering said treatment, and
(c) patient specific medical condition related information.

16. An information system according to claim 13, including
a repository including patient specific information wherein
said device management processor uses said received data items and said patient specific information in said repository for determining whether it is safe to use said medical device for delivering said treatment to said patient.

17. An information system according to claim 16, wherein
said repository includes at least one of, (a) medication information identifying characteristics of a medication being delivered in said treatment, (b) operational characteristics of a fluid infusion pump, (c) medical device location information, (d) medical device IP or Ethernet compatible MAC address, (e) authorized user identification information, (f) infusion pump fluid delivery flow rate, and (g) infusion pump fluid volume delivered.

18. An information system according to claim 13, wherein
said device management processor determines whether it is safe to use said particular medical device for delivering said treatment to said patient based on an absence of required data in a predetermined data field of said message of predetermined format.

19. An information system according to claim 13, wherein
said device management processor manages operation of said particular medical device using medical device location information derived using a communication address of a tag attached to said medical device.

20. An information system according to claim 19, wherein
said tag comprises a wireless identification device and said communication address comprises an IP (Internet Protocol) or Ethernet MAC address and
said device management processor derives said medical device location information using a map associating a plurality of medical device communication addresses with a corresponding plurality of medical device geographic locations.

21. An information system according to claim 19, including
an order processor for processing a physician order for initiating providing a treatment to a patient and wherein
said device management processor for receiving data items receives said data items from said order processor.

22. A system according to claim 21, wherein
said order processor initiates at least one of, (a) a communication of information associated with said particular medical device to a pharmacy information system for use in re-stocking medications, (b) a communication of information associated with said particular medical device to a medication order information system for use in monitoring use of particular fluid medications, and (c) a communication of information associated with said particular medical device to a patient management information system for use in monitoring patient usage of medications.

23. An information system for managing operation of medical devices in delivering treatment to a patient, comprising:
an authentication processor for receiving user identification information and determining a user is authorized to access an application used in managing a particular medical device used for delivering a treatment to a patient and inhibiting said access in response to a determination access is unauthorized;
a repository including patient specific information;
an device management processor for receiving data items in a message of predetermined format having predetermined data fields and for processing said data items in managing operation of said particular medical device and for using said received data items and said patient specific information in said repository for determining whether it is safe to use said medical device for delivering said treatment to said patient, in response to a user authorization determination, wherein if said user is registered, said device management processor associates said user with said medical device, and wherein said device management processor is adapted to register said user if said user is not registered; and
a communication interface enabling communication of said device management processor with said medical device.

24. An information system according to claim 23, wherein
said message comprises a non-scanned fixed format barcode identifier.

25. An information system according to claim 23, wherein
said data items include a patient identifier and said device management processor makes said safety determination differently for a patient without patient specific information available in said repository than for a patient having patient specific information available in said repository.

26. An information system according to claim 23, wherein
said device management processor makes said safety determination,
(a) for a patient without patient specific information available in said repository, based on an absence of required data in a predetermined data field of said message of predetermined format and
(b) for a patient having patient specific information available in said repository, based on comparing data in a predetermined data field of said message of predetermined format with data in said repository.

27. An information system according to claim 23, wherein
said device management processor, in response to said safety determination, initiates generation of an alert message for communication to a user, said alert message alerts regarding at least one of, (a) a new user registration, (b) when multiple login attempts fail in succession, (c) an inactive session greater than a predetermined duration, and (d) when a user attempts to access an unauthorized resource.

28. An information system according to claim 23, wherein
said authentication processor maintains a record indicating a hierarchy of users able to view corresponding hierarchically organized information based on user authorization level.

29. An information system according to claim 23, wherein
said data items include,
(a) a patient identifier,
(b) an identifier for identifying a physician order associated with said particular medical device used for delivering said treatment, and
(c) patient specific medical condition related information.

30. A method for managing operation of medical devices in delivering treatment to a patient, comprising the activities of:
processing a physician order for initiating providing a treatment to a patient;
receiving data items from said physician order comprising at least one of,
(a) a patient identifier and
(b) an identifier for identifying said physician order;
processing and using said data items in managing access to a medical device used for delivering said treatment to said patient;
associating at least one registered user with said medical device;
if a user is not registered, registering said user; and
enabling bi-directional communication with said medical device for delivery of information related to said physician order.

31. A method for managing operation of medical devices in delivering treatment to a patient, comprising the activities of:
receiving user identification information and determining a user is authorized to access an application used in managing a particular medical device used for delivering a treatment to a patient and inhibiting said access in response to a determination access is unauthorized;
if said user is registered, associating said user with said particular medical device;
if said user is not registered, registering said user;
receiving data items in a message of predetermined format having predetermined data fields and for processing said data items in managing operation of said particular medical device, in response to a user authorization determination; and
enabling communication with said medical device for communicating at least one of said data items.

32. An information system for managing operation of medical devices in delivering treatment to a patient, comprising:
an order processor for processing a physician order for initiating providing a treatment to a patient;
a device management processor for:
receiving data items from said order processor comprising at least one of,
(a) a patient identifier and.
(b) a non-scanned fixed format barcode identifier for identifying said physician order, and
processing and using said data items in managing access to a medical device used for delivering said treatment to said patient; and
a communication interface enabling bidirectional communication between said device management processor and said medical device.

33. A method for managing operation of medical devices in delivering treatment to a patient, comprising the activities of:
processing a physician order for initiating providing a treatment to a patient;
receiving data items from said physician order comprising at least one of,
(a) a patient identifier and
(b) a non-scanned fixed format barcode identifier for identifying said physician order;
processing and using said data items in managing access to a medical device used for delivering said treatment to said patient; and
enabling bidirectional communication with said medical device for delivery of information related to said physician order.

34. A method for managing operation of medical devices in delivering treatment to a patient, comprising the activities of:
receiving user identification information and determining a user is authorized to access an application used in managing a particular medical device used for delivering a treatment to a patient and inhibiting said access in response to a determination access is unauthorized;
receiving data items in a message of predetermined format having predetermined data fields and for processing said data items in managing operation of said particular medical device, in response to a user authorization determination, said message comprising at least one non-scanned fixed format barcode; and
enabling communication with said medical device for communicating at least one of said data items.
